(19) United States
(12) Patent Application Publication
(10) Pub. No.: US 2026/0028290 A1
(43) Pub. Date: Jan. 29, 2026

(54) METHOD OF FERTILIZING A PLANT WITH ZINC AND MANGANESE CO-DOPED CERIUM OXIDE NANOPARTICLES

(71) Applicant: Imam Abdulrahman Bin Faisal University, Dammam (SA)

(72) Inventors: Huseyin TOMBULOGLU, Dammam (SA); Fatimah ALGHOFAILI, Dammam (SA); Munirah A. ALMESSIERE, Dammam (SA)

(73) Assignee: Imam Abdulrahman Bin Faisal University, Dammam (SA)

(21) Appl. No.: 18/785,879

(22) Filed: Jul. 26, 2024

(51) Int. Cl. C05D 9/02; B82Y 30/00; C05G 5/10

(52) U.S. Cl. CPC C05D 9/02; B82Y 30/00; C05G 5/10

(57) ABSTRACT

A method of fertilizing a plant including applying a composition to a root of the plant, where the composition includes cerium oxide (CeO) nanoparticles. The CeO nanoparticles are doped with zinc (Zn) and manganese (Mn). The CeO nanoparticles include 1 weight percent (wt. %) to 3 wt. % of Zn and 1 wt. % to 3 wt. % of Mn, based on the total weight of the CeO nanoparticles.

### STATEMENT OF ACKNOWLEDGEMENT

The support of the Deanship of Scientific Research at Imam Abdulrahman bin Faisal University for funding this research work under project number 2019-058-IRMC is gratefully acknowledged.

### BACKGROUND

### Technical Field

The present disclosure is directed towards a plant fertilizer, more particularly directed towards zinc and manganese co-doped cerium oxide nanoparticles as a nanofertilizer for plants.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Nanosized materials are used in a variety of fields, such as electronics, communications, biomedicine, agriculture and environmental remediation. In agricultural practices, nanotechnology and nano-enabled fertilizers are promising agents to replace traditional fertilizers, which cause eutrophication and groundwater contamination when widely applied on the ground surface. Increases in human populations necessitates agricultural solutions with lower environmental impact.

Micronutrient deficiency in soil is a worldwide problem that reduces the growth performance of plants and leads to yield losses. Manganese (Mn), zinc (Zn) are essential micronutrients for plant growth and development. Up to a certain concentration, Mn, Zn, or Fe nanoparticles (NPs), as well as ZnO, Au, and TiO₂ NPs, can act as micronutrient sources. Further research is required to determine the incorporation of NPs into the plant body (especially crops) as well as translocation and even biomineralization. The production of novel NPs containing microelements for plant nutrition is a promising approach to compensate for the missing microelements.

The structure and morphology of NPs play a role in the translocation of plants. Biological barriers such as cell walls, membranes, Casparian strips, and vascular bundles, type of plants, environmental pH, NPs agglomeration, dissolution potential, and their interactions with the biomolecules are additional factors that impact the overall development of the plant. Although the mechanism is still complex, using more uniform NPs may help understand the translocation ability.

Each of the aforementioned methods and processes suffers from one or more drawbacks hindering their adoption. Accordingly, it is one object of the present disclosure to develop fertilizer compositions that impart improved plant growth at low concentrations with low or no toxicity. It is one object of the present disclosure to provide a method of fertilizing a plant with a fertilizer composition including Mn and Zn.

### SUMMARY

In an exemplary embodiment, a method of fertilizing a plant is described. The method includes applying a composition to a root of the plant. The composition includes cerium oxide (CeO) nanoparticles. The CeO nanoparticles are doped with zinc (Zn) and manganese (Mn). The CeO nanoparticles include 1 weight percent (wt. %) to 3 wt. % of the Zn and 1 wt. % to 3 wt. % of the Mn, based on a total weight of the CeO nanoparticles.

In some embodiments, the CeO nanoparticles are spherical.

In some embodiments, the CeO nanoparticles have an average size of 10 nanometers (nm) to 50 nm.

In some embodiments, the CeO nanoparticles include 45 wt. % to 60 wt. % Ce, 1 wt. % to 3 wt. % Zn, 1 wt. % to 3 wt. % Mn, and 25 wt. % to 40 wt. % oxygen (O), based on the total weight of the CeO nanoparticles.

In some embodiments, the CeO nanoparticles have a crystallite size of 10 nm to 14 nm.

In some embodiments, the CeO nanoparticles have a ceria cubic crystal structure.

In some embodiments, the CeO nanoparticles include Ce(III), Ce(IV), Mn(II), Mn(III), and Zn (II).

In some embodiments, the plant is a barley plant.

In some embodiments, the plant is under conditions of 22 degrees Celsius (° C.) to 25° C., 55% to 70% humidity, and 14 hours (h) to 18 h of light per day.

In some embodiments, applying the composition includes at least partially submerging the root of the plant in a fertilizer solution including the composition.

In some embodiments, the fertilizer solution includes 1 milligram per liter (mg/L) to 500 mg/L of the composition.

In some embodiments, the fertilizer solution further includes at least one compound selected from the group consisting of potassium nitrate, calcium nitrate, magnesium sulfate, potassium dihydrogen phosphate, ammonium dihydrogen phosphate, manganese chloride, zinc sulfate, copper sulfate, molybdic acid, sodium molybdate, ferric tartrate, iron(iii)-ethylenediaminetetraacetic acid (EDTA), and hydrates thereof.

In some embodiments, the plant uptakes the particles of the composition, and the leaves of the plant have a higher concentration of Zn, Ce, and Mn compared to a plant under the same conditions but without applying the composition.

In some embodiments, following the application of the composition, a root length of the plant is at least 10% longer when compared to that of a plant under the same conditions but without applying the composition.

In some embodiments, following the application of the composition, the plant has a higher concentration of chlorophyll-a, chlorophyll-b, and carotenoids than a plant under the same conditions but without applying the composition.

In some embodiments, the CeO nanoparticles include 1 wt. % of Zn and 1 wt. % of Mn, based on a total weight of the CeO nanoparticles, and the CeO nanoparticles do not damage the cell membrane or the root morphology of the plant.

In some embodiments, the composition further includes a pesticide.

In some embodiments, the pesticide is attached to a surface of the particles of the CeO nanoparticles.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A shows X-ray diffraction (XRD) patterns of Zn—Mn-doped cerium oxide nanoparticles (ZnMnCe NPs) with varying amounts of dopant, according to certain embodiments.

FIG. 1B shows an energy-dispersive-ray spectroscopy (EDX) spectrum of cerium oxide nanoparticles with 2% manganese and 2% zinc (denoted as 2% ZnMnCe NPs), according to certain embodiments.

FIG. 2A is a high-resolution transmission electron microscopy (HRTEM) image of cerium oxide nanoparticles with 1% manganese and 1% zinc (denoted as 1% ZnMnCe NPs), at a scale bar of 100 nanometers (nm), according to certain embodiments.

FIG. 2B is an HRTEM image of 1% ZnMnCe NPs at a scale bar of 50 nm, according to certain embodiments.

FIG. 2C is an HRTEM image of 1% ZnMnCe NPs at a scale bar of 10 nm, according to certain embodiments.

FIG. 2D is an HRTEM image of 1% ZnMnCe NPs at a scale bar of 5 nm, according to certain embodiments.

FIG. 3A is a field emission scanning electron microscopy (FESEM) image of undoped cerium oxide nanoparticles (denoted as 0% ZnMnCe NPs) at a scale bar of 500 nm, according to certain embodiments.

FIG. 3B is a FESEM image of 0% ZnMnCe NPs at a scale bar of 300 nm, according to certain embodiments.

FIG. 3C is a FESEM image of 1% ZnMnCe NPs at a scale bar of 500 nm, according to certain embodiments.

FIG. 3D is a FESEM image of 1% ZnMnCe NPs at a scale bar of 300 nm, according to certain embodiments.

FIG. 3E is a FESEM image of 2% ZnMnCe NPs at a scale bar of 500 nm, according to certain embodiments.

FIG. 3F is an FESEM image of 2% ZnMnCe NPs at a scale bar of 300 nm according to certain embodiments.

FIG. 3G is an FESEM image of cerium oxide nanoparticles doped with 3% manganese and 3% zinc (denoted as 3% ZnMnCe NPs), at a scale bar of 500 nm, according to certain embodiments.

FIG. 3H is an FESEM image of 3% ZnMnCe NPs at a scale bar of 300 nm, according to certain embodiments.

FIG. 4A shows an X-ray photoelectron spectroscopy (XPS) survey spectrum of 1% ZnMnCe NPs, according to certain embodiments.

FIG. 4B shows a core level XPS spectrum of C is in 1% ZnMnCe NPs, according to certain embodiments.

FIG. 4C shows a core level XPS spectrum of Ce 3d in 1% ZnMnCe NPs, according to certain embodiments.

FIG. 4D shows a core level XPS spectrum of Mn 2p in 1% ZnMnCe NPs, according to certain embodiments.

FIG. 4E shows a core level XPS spectrum of Zn 2p in 1% ZnMnCe NPs, according to certain embodiments.

FIG. 4F shows a core level XPS spectrum of O 1s in 1% ZnMnCe NPs, according to certain embodiments.

FIG. 5A is a bar graph comparing the root lengths of a control specimen and ZnMnCe NPs treated barley plants, after 4 days of germination, according to certain embodiments.

FIG. 5B is a bar graph comparing the shoot lengths of the control specimen and ZnMnCe NPs treated barley plants, after 4 days of germination, according to certain embodiments.

FIG. 5C is a bar graph comparing the germination ratio of the control specimen, and ZnMnCe NPs treated barley plants, according to certain embodiments.

FIG. 5D is a bar graph comparing the root lengths of a control specimen, and ZnMnCe NPs treated barley plants after 3 weeks of germination, according to certain embodiments.

FIG. 5E is a bar graph comparing the shoot lengths of the control specimen, and ZnMnCe NPs treated barley plants after 3 weeks of germination, according to certain embodiments.

FIG. 5F is an image of three-week-old seedlings of the control specimen, and ZnMnCe NPs treated barley plants, according to certain embodiments.

FIG. 5G is a bar graph comparing the relative water content (RWC) in the ZnMnCe NPs treated barley seedlings and the control specimen, according to certain embodiments.

FIG. 6A is a bar graph comparing the photosystem II (Y(II)) in the ZnMnCe NPs treated barley leaves and the control specimen, according to certain embodiments.

FIG. 6B is a bar graph comparing the electron transport rate (ETR) in the ZnMnCe NPs treated barley leaves and the control specimen, according to certain embodiments.

FIG. 6C is a bar graph comparing the Zn and Mn ratios on the parameters of chlorophyll fluorescence (Fv/Fm) in the ZnMnCe NPs treated barley leaves and the control specimen, according to certain embodiments.

FIG. 6D is an image of a pulse amplitude modulation (PAM) fluorometer measuring fluorescence emission response from barley leaves.

FIG. 7A is a bar graph comparing the chlorophyll-a content in barley seedlings treated with ZnMnCe NPs for three weeks and the control specimen, according to certain embodiments.

FIG. 7B is a bar graph comparing the chlorophyll-b content in barley seedlings treated with ZnMnCe NPs for three weeks and the control specimen, according to certain embodiments.

FIG. 7C is a bar graph comparing the carotenoid content in barley seedlings treated with ZnMnCe NPs for three weeks and the control specimen, according to certain embodiments.

FIG. 7D is a bar graph comparing the total pigment content in barley seedlings treated with ZnMnCe NPs for three weeks and the control specimen, according to certain embodiments.

FIG. 8A is a confocal micrograph of the root tip of 5 centimeters (cm) of the control specimen barley plants, according to certain embodiments.

FIG. 8B is a confocal micrograph of the root tip of 5 cm of 1% ZnMnCe NPs treated barley plants, according to certain embodiments.

FIG. 8C is a confocal micrograph of the root tip of 5 cm of 2% ZnMnCe NPs treated barley plants, according to certain embodiments.

FIG. 8D is confocal micrographs of the root tip of 5 cm of 3% ZnMnCe NPs treated barley plants, at various magnifications, according to certain embodiments.

FIG. 9A is a scanning electron microscopy (SEM) image of the root tip of 0.5 cm of the control specimen barley plant, according to certain embodiments.

FIG. 9B and FIG. 9C are magnified SEM images of the root tip of 0.5 cm of the control specimen barley plant, according to certain embodiments.

FIG. 9D is an SEM image of the root tip of 0.5 cm of the 1% ZnMnCe NPs treated barley plant, according to certain embodiments.

FIG. 9E and FIG. 9F are magnified SEM images of the root tip of 0.5 cm of the 1% ZnMnCe NPs treated barley plant, according to certain embodiments.

FIG. 9G is an SEM image of the root tip of 0.5 cm of the 2% ZnMnCe NPs treated barley plant, according to certain embodiments.

FIG. 9H and FIG. 9I are magnified SEM images of the root tip of 0.5 cm of the 2% ZnMnCe NPs treated barley plant, according to certain embodiments.

FIG. 9J is an SEM image of the root tip of 0.5 cm of the 3% ZnMnCe NPs treated barley plant, according to certain embodiments.

FIG. 9K and FIG. 9L are magnified SEM images of the root tip of 0.5 cm of the 3% ZnMnCe NPs treated barley plant, according to certain embodiments.

FIG. 10A is a HRTEM micrograph showing the nucleus in a barley root cell of the control specimen, according to certain embodiments.

FIG. 10B is a HRTEM micrograph showing vacuole and cytoplasm in a barley root cell of the control specimen, according to certain embodiments.

FIG. 10C is a HRTEM micrograph showing the cell membrane and internuclear space in a barley root cell of the control specimen, according to certain embodiments.

FIG. 10D is HRTEM micrograph showing the vacuole of a barley root cell treated with 3% ZnMnCe NPs, according to certain embodiments.

FIG. 10E is a HRTEM micrograph showing the cytoplasm and vacuoles in a barley root cell treated with 3% ZnMnCe NPs, according to certain embodiments.

FIG. 11 shows random amplified polymorphic DNA polymerase chain reaction (RAPD-PCR) band patterns of ZnMnCe NPs treated and control barley roots, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

When describing the present disclosure, the terms used are to be construed in accordance with the following definitions, unless a context dictates otherwise.

Embodiments of the present invention will now be described more fully hereinafter. To aid in the understanding of these embodiments, reference will be made to the accompanying drawings, which depict some, but not all, of the disclosed embodiments. These drawings are an integral part of this description and should be carefully reviewed to fully grasp the invention.

In the drawings, reference numerals designate identical or corresponding parts throughout the several views. Further, as used herein, the words “a,” “an,” and the like generally mean “one or more” unless stated otherwise.

Furthermore, the terms “approximately,” “approximate,” “about,” and similar terms generally refer to ranges that include the identified value within a margin of 20%, 10%, or preferably 5%, and any values between.

The terms ‘include’, ‘includes,’ ‘including,’ ‘have,’ ‘has,’ or ‘having’ are used in an open-ended and non-limiting manner unless specifically stated otherwise. This means that these terms are not meant to restrict the scope of the disclosure but rather to provide a broad understanding of the elements involved.

Where a numerical limit or range is stated herein, the endpoints are included. Also, all values and subranges within a numerical limit or range are specifically included as if explicitly written out.

Aspects of this disclosure are directed to nanoparticles (NP) containing two essential plant micro-nutrients, namely zinc (Zn) and manganese (Mn), co-doped on cerium oxide (CeO). The Zn/Mn-doped cerium oxide nanoparticles (ZnMnCe NPs) were evaluated for their potential in use as a plant fertilizer and the results indicate that the plants treated with ZnMnCe NPs resulted in improved plant growth.

A method of fertilizing a plant is described. The plant may be a member of the family Poaceae or grass. Suitable examples of grasses belonging to the Poaceae family include grain crops (for example—barley, maize, corn, rice, rye, oats, sorghum, wheat), leaf and stem grass (for example—bamboo, marram grass, meadow grass, reeds, sugarcane); lawn grasses (for example—bahiagrass, bentgrass, bermudagrass, bluegrass, buffalograss, centipede grass, fescue, ryegrass); or ornamental grasses. In a preferred embodiment, the plant is barley. Although the description and the examples herein provided refer to the use of the fertilizer composition (also referred to as composition) for the plant barley, it may be understood by a person skilled in the art that the composition of the present disclosure may be adapted for use to any other grass in the Poaceae family, albeit with a few variations, as may be obvious to a person skilled in the art.

The method includes applying a composition to the root of the plant. The composition may be applied to a whole root or at least a part of a root of the plant. In some embodiments, the composition is applied to the plant by submerging at least a part of the root, preferably the whole root, of the plant in a fertilizer solution, including the composition. In some embodiments, the fertilizer solution may be sprayed on at least a part or a whole root of the plant. In some embodiments, the fertilizer solution may be dried and can be applied the composition can be applied in the form of a powder. The powder may be carefully applied to at least a part or preferably the whole root of the plant. In some embodiments, the composition may be applied to other plant parts as well, such as leaf, stem, fruit, root, or any other part thereof, alone or in combination.

In preferred embodiments, the composition is applied to the plant by submerging at least a part of the root, preferably the whole root, of the plant, in a fertilizer solution including the composition. In a preferred embodiment, the fertilizer solution includes the composition suspended in a liquid. In some embodiments, the liquid is such as but not limited to water, and saline. In some embodiments, the fertilizer solution may include sources for other micronutrients and/or macronutrients. As used herein, “micronutrients” refers to elements ‘required in small or trace amounts for plant growth, for example, molybdenum, nickel, copper, zinc, manganese, boron, iron, and chloride. As used herein, “macronutrients” refers to elements typically required in large amounts for plant growth, for example, sulfur, phosphorus, phosphate, magnesium, calcium, potassium, nitrogen, oxygen, carbon, and hydrogen. In some embodiments, the fertilizer solution further comprises at least one compound selected from the group consisting of potassium nitrate, calcium nitrate, magnesium sulfate, potassium dihydrogen phosphate, ammonium dihydrogen phosphate, manganese chloride, zinc sulfate, copper sulfate, molybdic acid, sodium molybdate, ferric tartrate, iron(III)-EDTA, and hydrates thereof. In some embodiments, the liquid is Hoagland solution. As would be known to one of ordinary skill in the art, Hoagland solution is intended to mimic nutrient rich soil. In a preferred embodiment, the plant is grown hydroponically, i.e., without soil.

In some embodiments, the concentration of the composition in the fertilizer solution is in a range of 1-500 mg L⁻¹, preferably 50-400 mg L⁻¹, preferably 100-400 mg L⁻¹, preferably 100-200 mg L⁻¹. On application of the fertilizer solution to the root of the plant, the plant uptakes the composition and it is translocated to other parts of the plant, such as leaves.

In an embodiment, the composition is applied for 1-100 days, preferably 2-90 days, 3-80 days, 5-70 days, 6-60 days, 7-50 days, 8-40 days, 9-30 days, or about 10-20 days. In some embodiments, the fertilizer solution is continuously pumped with air during the application process. This is done to prevent agglomeration of the particles in the fertilizer solution.

In some embodiments, during application, the plant is under conditions of 20-35° C., preferably 21-33° C., preferably 22-30° C., preferably 22-25° C. In some embodiments, during application, the plant is under conditions of 20-90% humidity, preferably 30-80%, 40-70%, 50-60%, or about 55% humidity. In some embodiments, during application, the plant is under conditions of 8-20 hours of light per day, preferably 10-18, 12-16, or about 14 hours of light per day. In some embodiments, the plant is under conditions of 22 to 25° C., 55% to 70% humidity, and 14 h to 18 h of light per day.

The composition includes cerium oxide (CeO) nanoparticles. In an embodiment, the CeO NPs may be doped with at least one element selected from the group consisting of Zn, Cu, Ni, Co, and Mn. In a preferred embodiment, the CeO NPs may be doped with at least one element, preferably both, selected from the group consisting of Zn and Mn.

In general, the CeO NPs can be any shape known to one of ordinary skill in the art. Examples of suitable shapes the CeO NPs may take include spheres, spheroids, lentoids, ovoids, solid polyhedra such as tetrahedra, cubes, octahedra, icosahedra, dodecahedra, hollow polyhedral (also known as nanocages), stellated polyhedral (both regular and irregular, also known as nanostars), triangular prisms (also known as nanotriangles), hollow spherical shells (also known as nanoshells), tubes (also known as nanotubes), nanosheets, nanoplates, nanodisks, rods (also known as nanorods), and mixtures thereof.

In some embodiments, the CeO NPs are spherical and have an average diameter in the range of 1 to 100 nm, preferably in the range of 10 to 90 nm, 20 to 80 nm, 30 to 70 nm, 40 to 60 nm, or about 50 nm. In some embodiments, the particles of the CeO NPs are spherical and have an average diameter or crystallite size of 10-20 nm, preferably 12-19 nm, preferably 13-17 nm, preferably 14-16 nm, preferably 14 nm. In a preferred embodiment, the particles of CeO NPs are less than 20 nm in size to facilitate uptake into the plant tissue. The particles of CeO NPs are aggregated, forming an interconnected network. In other words, there are no lone CeO NPs particles which are not touching at least one other CeO NPs particle in the aggregated network. In some embodiments, the interconnected network is a chain of the CeO NPs with a width of 100-200 nm, preferably 110-190 nm, 120-180 nm, 130-170 nm, 140-160 nm, or about 150 nm, and a length of at least 1 μm, preferably 1-10 μm, 2-9 μm, 3-8 μm, 4-7 μm, or 5-6 μm.

The CeO nanoparticles may exist in various crystal phases, such as cubic, double hexagonal close pack (dhcp), face-centered cubic, body-centered cubic, orthorhombic, monoclinic, body-centered tetragonal, with the cubic phase being the predominant form. In some embodiments, the CeO nanoparticles have a ceria cubic crystal structure. The cerium in the CeO nanoparticles can exist in +3 (Ce(III)) and +4 (Ce(IV)) oxidation states. The CeO nanoparticles doped with Zn and Mn include various oxidation states selected from the group consisting of Ce(III), Ce(IV), Mn(II), Mn(III), and Zn (II).

In some embodiments, the CeO nanoparticles are doped with 1-3 wt. %, including 1, 1.5, 2, 2.5, and 3 wt. % of the zinc, and 1-3 wt. %, including 1, 1.5, 2, 2.5, and 3 wt. % of the manganese, based on the total weight of the CeO nanoparticles. In a preferred embodiment, the CeO nanoparticles are doped with 1 wt. % of zinc and 1 wt. % of manganese based on the total weight of the CeO nanoparticles. The amount of doped Mn and Zn may be the same or different, preferably the same, i.e., 1% Mn and 1% Zn.

The CeO nanoparticles doped with zinc and manganese comprise 45-60 wt. % Ce, preferably 50-55 wt. %, preferably 51-54 wt. %, preferably 52-53 wt. %, preferably 52.3 wt. % of Ce; 1-3 wt. % Zn, preferably 1-2 wt. %; 1-3 wt. % Mn, preferably 1-2.2 wt. %; and 25-40 wt. % 0, preferably 30-35 wt. %, based on the total weight of the CeO nanoparticles.

In some embodiments, the composition further includes a pesticide. Suitable examples of pesticides include, but are not limited to, abamectin, acephate, acetamiprid, allethrin, arsenic trioxide, azadirachtin, bifenthrin, borate, canola oil, carbaryl, chlorantraniliprole, clothianidin, cryolite, cyfluthrin, cypermethrin, diflubenzuron, dinotefuran, disulfoton, emamectin benzoate, fipronil, fluvalinate, Heterorhabditis spp. nematodes, horticultural oil, hydramethylnon, imidacloprid, jojoba oil, lambda-cyhalothrin, malathion, neem oil, Nosema locustae, permethrin, pyrethrin, resmethrin, rotenone, silica gel, soap, spinosad, Steinernema spp. nematodes, sulfluramid, thiamethoxam, 2,4-D, benefin, bensulide, bentazon, bromoxynil, cacodylic acid, calcium acid methanearsonate, carfentrazone, chlorsulfuron, clethodim, DCPA, dicamba, dichlobenil, dimethenamid-P, diquat, dithiopyr, EPTC, fluazifop, fluroxypyr foramsulfuron, glufosinate, glyphosate, halosulfuron, hexazinone, imazapyr, isoxaben, MCPA, mecoprop, metolachlor, MSMA, napropamide, oryzalin, oxadiazon, oxyfluorfen, pelargonic acid, pendimethalin, prodiamine, pronamide, quinclorac, sethoxydim, siduron, sulfosulfuron, tebuthiuron, triclopyr, trifloxysulfuron-sodium, trifluralin, bordeaux mixture, calcium polysulfide, chlorothalonil, copper ammonium complex, copper hydroxide, copper octanoate, copper oxychloride sulfate, cupric hydroxide, fosetyl-al, horticultural oil, jojoba oil, mancozeb, myclobutanil, neem oil, phosphorous acid, potassium bicarbonate, resmethrin, soap, sulfur, thiophanate methyl, tribasic copper sulfate, triforine, ferric sodium EDTA, iron phosphate, metaldehyde, and/or combinations thereof.

In some embodiments, the pesticide is attached to a surface of the particles of the CeO nanoparticles. In some embodiments, the attachment occurs through a functionalized coating on a surface of the CeO nanoparticles. In some embodiments, the attachment is through a chemical covalent bond or through physical attractive forces, such as van der Waals forces, hydrogen bonding, and/or hydrophobic interactions.

In some embodiments, the coating is a hydrophilic or hydrophobic coating. Examples of a hydrophilic coatings include glycols, alcohols, sulfates, sulfonates, carboxylates, and phosphates. Examples of hydrophobic coatings include compounds with extended carbon chains such as a carbon chain having up to 30 carbon atoms, preferably 5-25 carbons, 10-20 carbons or about 15 carbons. Certain other examples for coatings include dextran, polyvinyl alcohol, Tween80®, gold nanocages, chitosan, fluorinated chains and/or mixtures thereof. The choice of the coating material is dependent on the pesticide that is to be applied.

Upon application of the fertilizer solution, the plant uptakes the particles of the composition, where the leaves of the plant have a higher concentration of Zn, Ce, and Mn compared to a plant under the same conditions but without applying the composition. In some embodiments, following the application, the root length of the plant it at least 10% longer, preferably 20%, 30%, 40%, 50%, 60%, 70%, 80%, 90%, or 100% longer compared to a plant under the same conditions but without applying the composition. In some embodiments, following the application, the plant has a higher concentration of chlorophyll-a, chlorophyll-b, and carotenoids than a plant under the same conditions but without applying the composition. The CeO nanoparticles doped with 1% zinc and 1% manganese do not damage the cell membrane or root morphology of the plant.

While not wishing to be bound to a single theory, it is thought that the plant uptakes the doped CeO nanoparticles, thereby increasing an amount of the essential micronutrients Zn and Mn in the plant tissue, resulting in improved growth and pigment concentrations. However, if the amount of Zn and Mn in the CeO nanoparticles is greater than 1% each, the composition of NPs does not lead to growth improvement; in contrast, they cause growth inhibition and potential toxic effects. This is due to disruptions in the root morphology, which may affect the nutrient trafficking and homeostasis that eventually influence the physical condition and growth of the plant.

### EXAMPLES

The following examples demonstrate using zinc/manganese-co-doped cerium oxide nanoparticles (NPs) (ZnMnCe NP) as a plant fertilizer. The examples are provided solely for illustration and are not to be construed as limitations of the present disclosure, as many variations thereof are possible without departing from the spirit and scope of the present disclosure.

### Example 1: Synthesis of Zinc (Zn)/Manganese (Mn)—Co-Doped Cerium Oxide (CeO₂) Nanoparticles (NPs) and Characterization Techniques

A sol-gel technique was utilized to prepare the Zn—Mn-doped cerium oxide NPs (ZnMnCe NPs). First, a predetermined quantity of anhydrous cerous nitrate (Ce(NO₃)₃) was dissolved in 25 milliliters (mL) of methanol with 1%, 2%, and 3% of each of manganese nitrate (Mn(NO₃)₂) and zinc nitrate (Zn(NO₃)₂). 2.5 mL of ammonium solution was mixed in drops to obtain a pinkish precipitate. The precipitate was filtered and washed with methanol several times, followed by overnight drying at 80 degrees Celsius (° C.). The resulting powder was calcined at 400° C. in an ambient environment for 4 hours (h).

The structures of the obtained ZnMnCe samples were investigated by X-ray diffraction (XRD), using a Malwern Panalytical instrument with copper K-α (Cu-Kα) radiation of wavelength (λ)=1.54059 angstrom (Å). The chemical compositions and oxidation states of the samples were analyzed with an X-ray photoelectron spectroscopy (XPS) instrument by Thermo Fisher Scientific, where C1s peak at 284.8 electronvolts (eV) was utilized as the reference for calibrating the XPS spectrum. The sample morphology was recorded by field emission scanning electron microscopy FESEM using a Thermo Fisher Scientific instrument and interfaced with an energy-dispersive-ray spectroscopy (EDX) spectrometer for further elemental analysis.

### Example 2: Seed Treatment and Growth Conditions

Petri dishes containing two layers of sterile tissue paper were used to germinate 20 barley seeds. A Hoagland solution was made using 6 millimolar (mM) of potassium nitrate (KNO₃), 0.1 micromolar (μM) of ferric ethylenediaminetetraacetic acid (Fe-EDTA), 4 mM of calcium nitrate (Ca(NO₃)₂), 1 mM of ammonium dihydrogen phosphate (NH₄H₂PO₄), 0.02 grams (g) of 85% molybdenum trioxide (MoO₃), 2 mM of magnesium sulfate (MgSO₄), 50 μM of boric acid (H₃BO₃), 9 μM of manganese (II) chloride (MnCl₂), 0.8 μM of zinc sulfate (ZnSO₄), and 0.3 μM of copper sulfate (CuSO₄). 200 milligrams per liter (mg/L) of colloidal ZnMnCe NPs with 1%, 2%, and 3% concentrations of the Zn and Mn ions were suspended in different Hoagland solution samples. The resultant mixtures were subjected to sonication for 30 minutes (min) in water baths using a Powersonic 410, Hwashin Technology, Korea, to avoid the aggregation of colloidal NPs.

The mixtures and the unmixed Hoagland solution were poured into different Petri dishes containing the barley seeds. The three NP-treated Petri dishes were incubated in the dark for four days at a controlled temperature of 20° C. to 25° C. and 60% to 70% humidity. The barley seeds were considered germinated when the roots of 65% of the control specimen seeds were no less than 0.5 centimeters (cm). The control specimen refers to the seeds without NPs treatment. At least eight uniform seedlings were moved to pots of 50 mL filled with the Hoagland solution containing the NPs and the Hoagland solution without the NPs. The seedlings were kept in a greenhouse for three weeks under 20° C. to 25° C., with light and dark cycles of 16 h and 8 h at 60% to 70% humidity; the Hoagland solution containing the NPs was renewed every 3 days. After 3 weeks, fresh and dry weight, plant growth, chlorophyll content, photosynthetic parameters, relative water content (RWC), elemental compositions, deoxyribonucleic acid (DNA) extraction, and random amplified polymorphic DNA polymerase chain reaction (RAPD-PCR) analysis were conducted.

### Example 3: Chlorophyll, Carotenoids, Photosynthetic Parameters Evaluation

The photosynthetic parameter status was determined by measuring the chlorophyll fluorescence of the barley leaves using a pulse amplitude modulation (PAM) fluorometer, Walz® GmbH, Effeltrich, Germany. Measurements were taken from the first leaf of 3-week-old seedlings from at least three different seedlings. Before the measurements, plants were adapted to darkness for 30 minutes before placing a clip holder on each leaf and exposing the plants to an actinic pulse light of the highest emission wavelength of 450 nm. At 1 mm from the light guide tip, the photosynthetic photon flux density (PPFD) of 1,500 mol photon per square meter per second (m⁻² s⁻¹) of blue light was applied. Various photosynthetic parameters such as minimum fluorescence (Fo), maximum fluorescence (Fm), the effective photochemical quantum yield of the photosystem II (Y(II)), and electron transport rate (ETR) were calculated using WinControl-3.29 software, Walz® GmbH, Effeltrich, Germany. A PIN-photodiode was used to detect the fluorescence signal. The ratio of variable fluorescence (Fv) to maximum quantum efficiency of PSII (Fm), (Fv:Fm) was computed.

The contents of chlorophyll a, chlorophyll b, and carotenoid were calculated from 50 milligrams (mg) of tissues from the tips of three fresh leaves. First, these leaves were cut into tiny pieces and then smashed with 4 mL of 80% acetone. Next, the colloidal suspension was moved to tubes of 2 mL and subjected to centrifugation for 15 min at 4000 revolutions per minute (rpm). Later, the supernatants were transferred to 96-well cell culture dishes from Thermofisher Scientific to record the absorption spectra at 663 nm, 646 nm, and 470 nm using a plate reader from BioTek, Synergy Neo 2. The contents of chlorophyll a, chlorophyll b, and carotenoid were quantified using the expression given below.

$$\begin{matrix}{Chl}_{a} = 12.21 \times {A}_{663} - 2.81 \times {A}_{646} \\ Ch {l}_{b} = 20.13 \times {A}_{646} - 5.03 \times {A}_{663} \\ Car = ( 10 \; 00 \times {A}_{470} - 3.27 \times {Chl}_{a} - 104 \times {Chl}_{b} ) \div 227\end{matrix}$$

### Example 4: RWC Assay of Barley Leaves

The relative water content (RWC) of the barley plant leaves was obtained. Three healthy and expanded leaves were selected from every set of barley plants and the leaves were cut to 6 cm to 10 cm blades with scissors. These leaves were weighed to get the fresh weight (FW). Later, these leaves were kept in a plastic bag containing 5 mM calcium chloride (CaCl₂) solution. The petiole was faced down, immersed in the CaCl₂ solution with the bag tightly closed. After incubating in darkness for 8 h, the leaves were taken out and kept between paper towels for drying, followed by the turgid weight (TW) measurement of the leaves. The leaves were then oven-dried at 60° C. for 72 h, and the dry weight (DW) was recorded. The RWC of the leaves was determined using the relation mentioned below.

$$RWC = ( F W - DW ) / ( TW - D W )$$

### Example 5: DNA Isolation and Random Amplified Polymorphic DNA Polymerase Chain Reaction (RAPD-PCR) Analysis

After three weeks of NP treatment, the seedlings of control and treated barley plants were harvested and instantaneously ground in liquid nitrogen. A GeneJET plant genomic DNA purification mini kit, Thermo Scientific, USA, was used to record the total genomic DNA in the leaves. The purity and quality of the DNA template were verified utilizing the absorbance ratio of 260 nm to 280 nm with a NanoDrop, Thermo, and gel electrophoresis analysis. RAPD-PCR test was carried out using a Nexus GSX1 thermocycler, Eppendorf, US. Twenty-five microliters (μL) of the reaction mixture was made from 12.5 μL of GeneAll® 2× master mix, 5 μL of OPA-8 primer mix, 1 μL of magnesium chloride (MgCl₂), 5 μL of DNA template, and 25 μL of distilled water (dH₂O). The cycling conditions were set at 94° C. for 3 min, followed by 45 cycles at 94° C. for 1 min, at 36° C. for 1 min, at 72° C. for 2 min, and finally at 72° C. for 5 min. The polymerase chain reaction (PCR) product was loaded in a 2% agarose gel and subjected to electrophoresis for 45 min. The observation was made under an ultraviolet (UV)-transilluminator, Biorad Gel Doc XR+ Imaging System interfaced with Image Lab Software.

### Example 6: Scanning Electron Microscopy (SEM) Analysis of Roots

After 21 days of exposure, the structural and surface properties of the roots were analyzed by an SEM using Inspect S50, FEI. The apexes of fresh roots were cut and washed in phosphate-buffered saline (PBS) of pH 7.4 before being soaked overnight in a 4% glutaraldehyde solution. The specimens were dehydrated progressively with ethanol having gradients of 25%, 50%, 75%, 95%, and 100%. After being dehydrated, the specimens were dried using a Leica EM CPD300, sputter-coated with gold using Quorum Q150R ES, and placed for SEM observation under 20 kilovolts (kV).

### Example 7: Confocal Microscopic Analyses of Roots

The cells of the root tips were examined for potential membrane damage using propidium iodide (PI) dye. PI dye may enter the cytoplasm of injured cells through damaged cell membranes and color the nucleus. A sterile razor blade was used to cut 10 mm of the root tips after the roots were stained by submerging the roots for 4 min in a 1% dilute PI mixture, P-4170 from Sigma. Excess color was eliminated by soaking the tissues twice in H₂O for 1 min each. The roots were then mounted on slides, and cover slides were positioned on the roots. The plant roots were observed by settling on red-colored PI dye using an LSM 900, Zeiss, Germany confocal laser field microscopy that operated with the excitation and emission wavelengths of 536 nm and 617 nm, respectively.

### Example 8: Transmission Electron Microscopic (TEM) Analysis of Tissues

The roots and shoots were cut out in tiny pieces of less than 1 millimeter (mm) in water and were then fixed with 3% glutaraldehyde in phosphate buffer at 4° C. for 3 h. The obtained specimens were washed three times in a sodium phosphate buffer at 4° C. for 1 hour, 12 hours, and 1 hour before being dipped in 1% osmium tetroxide buffer for 3 hours at ambient conditions. To eliminate the surplus osmium tetroxide, the specimens were washed in deionized water and dehydrated progressively with ethanol having gradients of 20%, 50%, 70%, and 90% for 20 min each on a rotator. The specimens were further dehydrated through three changes of 100% ethanol in each step for 30 min. The specimens were dehydrated through three changes of propylene oxide for 20 min in each step. The dehydrated samples were infiltrated and oven-cured at 60° C. for 12 h, then sectioning the tissue to an 80 nm thickness using an RMC Boeckeler Powertome PC ultramicrotome, USA. The obtained sections of the specimens were stained after placing them on the copper grid. A Thermofisher Talos L120C G2 Transmission Electron Microscope was used to obtain the bright-field images of the specimens.

### Example 9: Elemental Analysis of Samples

After 3 weeks, all the NPs-treated and control specimens of leaves and roots were oven-dried at 70° C. for 4 days before being crushed in a ceramic mortar. Following EPA procedure 3051, the samples were digested in Teflon-1 microwave digesting vessels of 10 mL MARS Xpress Vessels, PFA, CEM. In this process, a mixture of 65% plasma pure nitric acid and 30% hydrogen peroxide in a ratio of 1:4 was dispensed on the dry specimen powder. Macro and microelements were analyzed using an ICP-OES, PerkinElmer Avio® 500 ICP-OES Scott/Cross-Flow, USA.

### Example 10: Statistical Analyses

Random sampling of a minimum of three specimens was used to conduct all the experiments, and the data obtained was analyzed using t-test variance. The achieved values of the NP-treated specimens were tallied with those of control specimens to determine their significance. p<0.05, p<0.01, and p<0.005. an asterisk * denotes these differences as *=p<0.05, **=p<0.01, and ***=p<0.005).

### Example 11: Nanoparticle Characterization

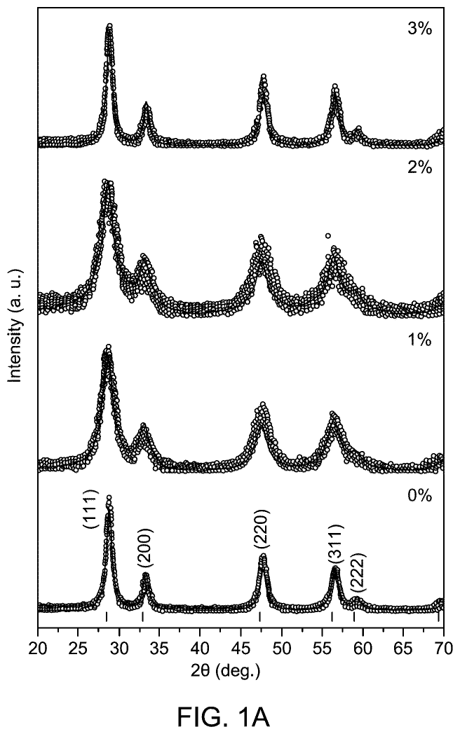

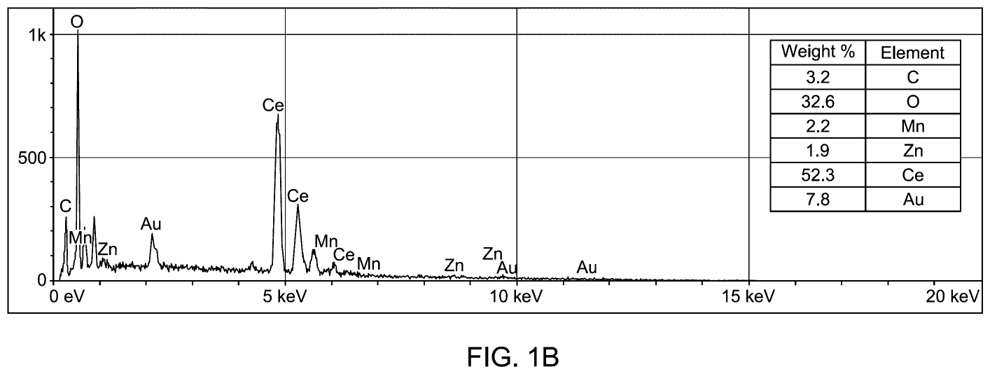

FIG. 1A shows an X-ray powder pattern used to conduct a structural analysis of ZnMnCe NPs. All diffraction peaks of the doped samples matched the structure of the host cubic ceria without any other phases. The expanded peaks in every sample indicated that the crystals were minute. The image analysis software Match 3! was used to perform Rietveld reference fitting to determine the lattice constants, average crystal size, and cell volume, as shown in Table 1. The lattice constant values ‘a’ were increased as the Zn—Mn ratio increased due to ceria lattice expansion. The crystallite size was computed using Scherrer's equation, which showed slight variation in a range of 10 nm to 14 nm when the Zn—Mn amount was increased.

TABLE 1
The structural parameters of ZnMnCe NPs.

| | | | D_{XRD} | | |
|---|---|---|---|---|---|
| x (%) | a (Å) | V (Å³) | (nm) ±0.03 | χ² | R_{Bragg} |
| 0 | 5.4092 | 158.27 | 11.9 | 1.8 | 12.5 |
| 1 | 5.4162 | 158.88 | 13.6 | 1.5 | 11.9 |
| 2 | 5.4188 | 159.11 | 13.8 | 1.2 | 12.1 |
| 3 | 5.4222 | 159.41 | 10.7 | 1.6 | 11.9 |

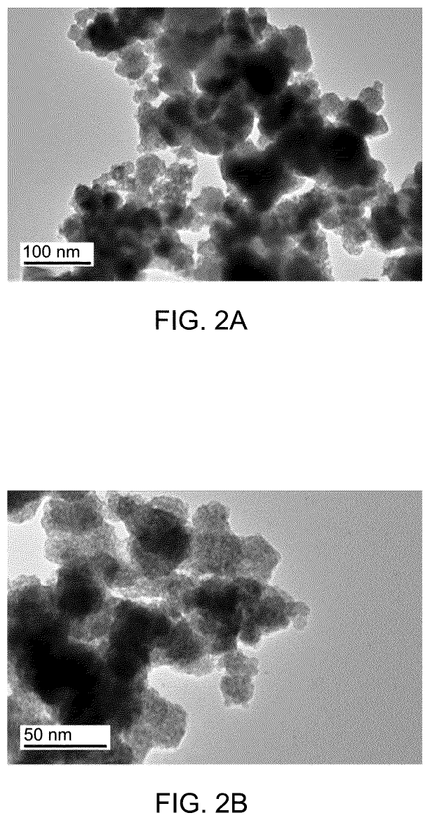

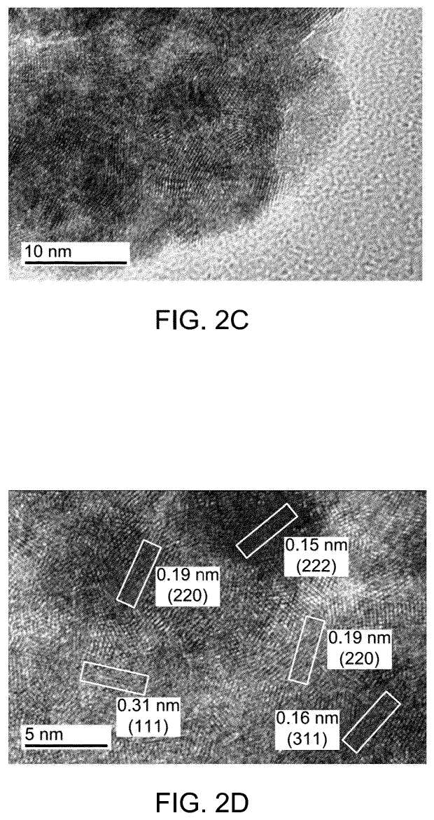

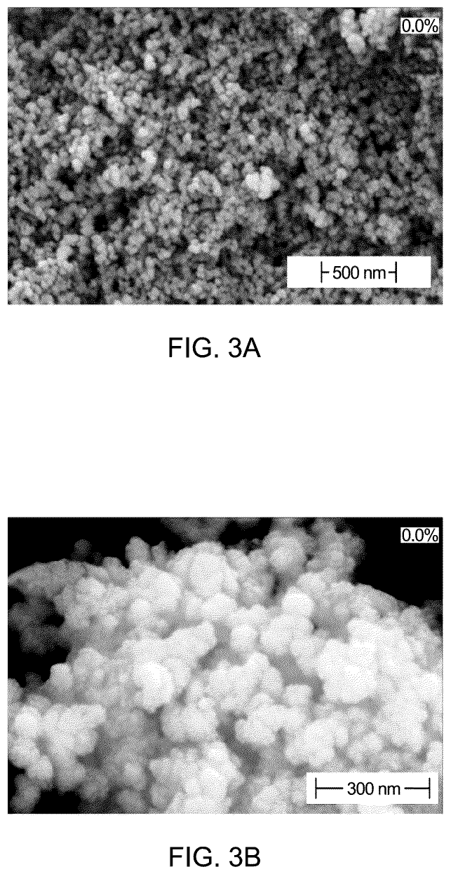

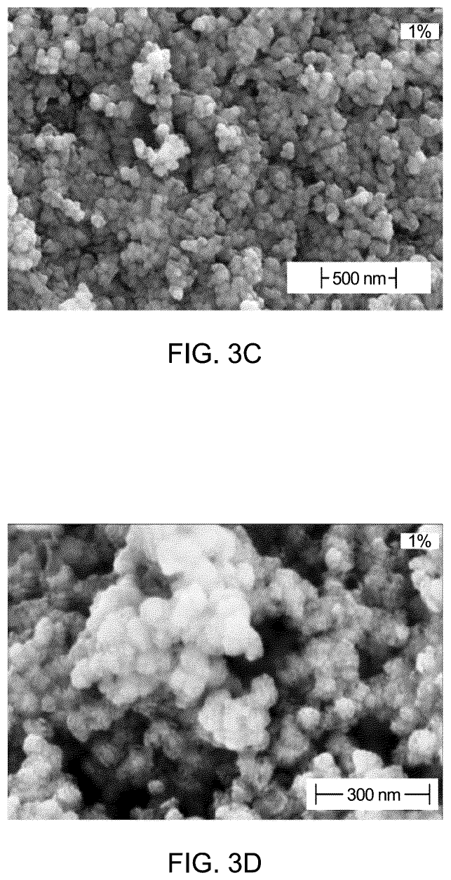

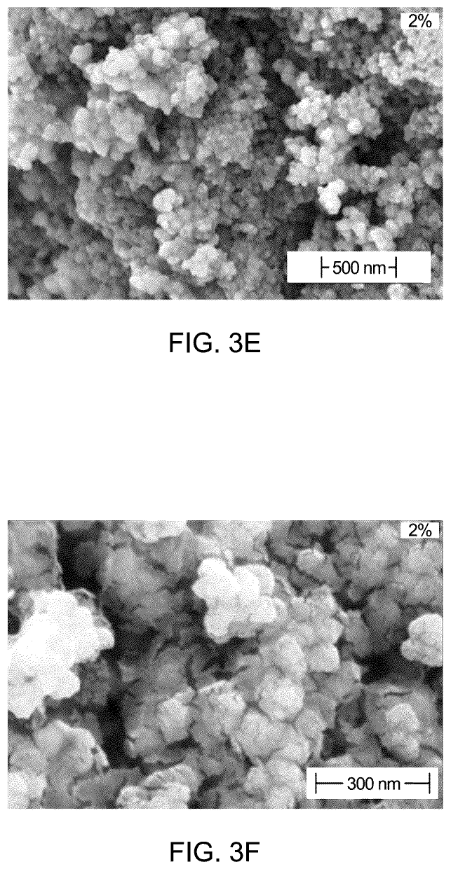

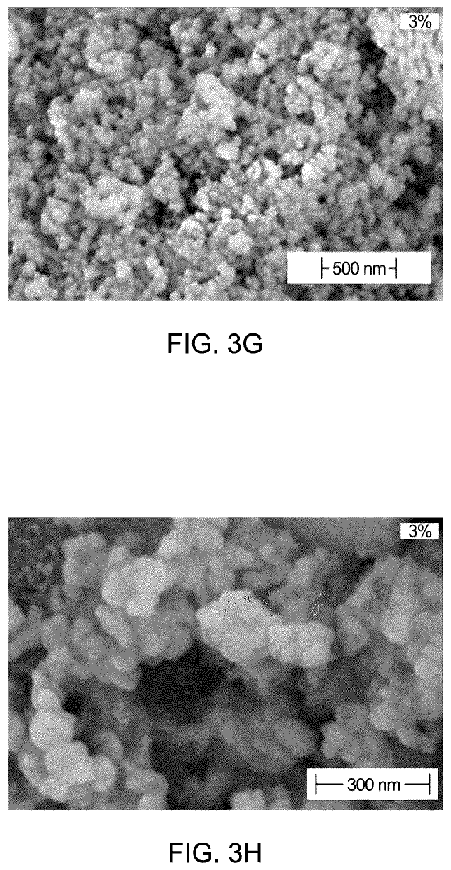

FIGS. 3A-3H illustrates the magnified field emission scanning electron microscopy (FESEM) micrographs of ZnMnCe NPs showing an assembly of minute spherical particles. FIG. 1B illustrates the energy-dispersive X-ray (EDX) spectra of 2% ZnMnCe NPs, which shows the presence of chemical elements cerium (Ce), Mn, Zn, and oxygen (O). FIGS. 2A-2D illustrate the transmission electron microscopy (TEM) and high-resolution transmission electron microscopy (HRTEM) micrographs of 1% ZnMnCe NPs, which revealed a dense accumulation of minute spherical particles, supporting the FESEM results. The values of d-spacing evaluated from HRTEM image analysis confirmed the formation of the cubic ceria phase.

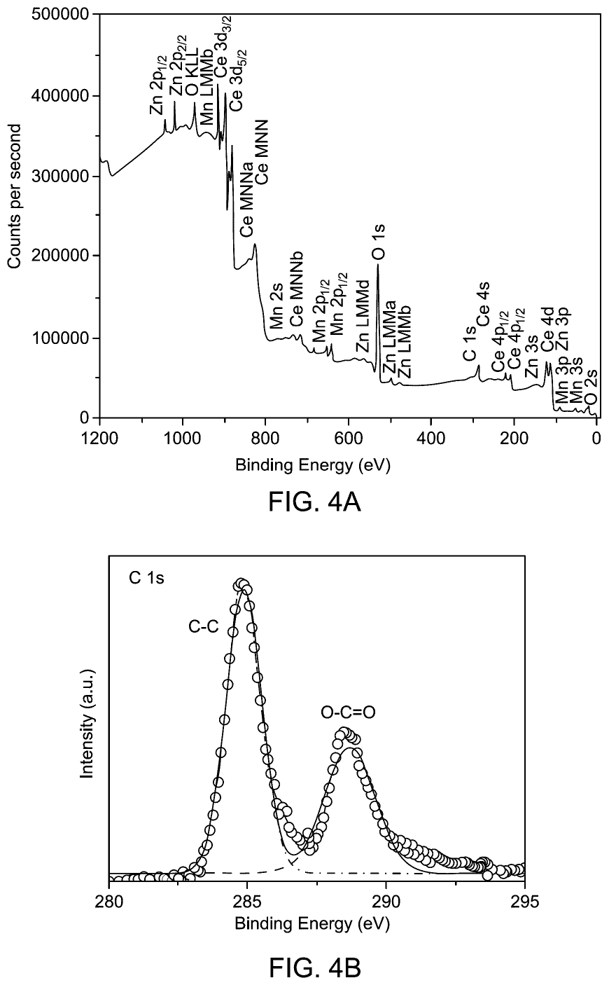

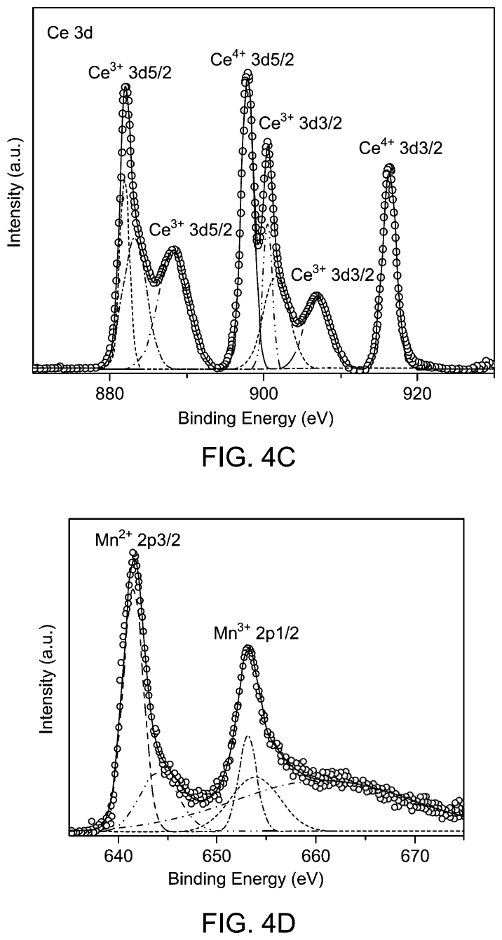

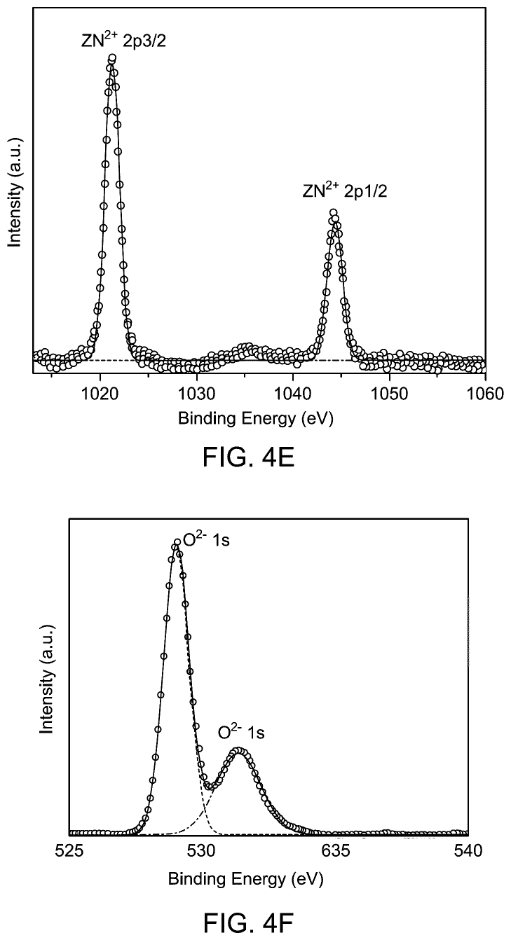

FIGS. 4A-4F illustrate the spectra of XPS analysis carried out to investigate the elemental compositions and the oxidation states of Zn/Mn-doped CeO NPs. The survey spectrum was implemented to confirm the existence of Ce, Zn, Mn, and O, as shown in FIG. 4A. The peaks of the C1s spectrum corresponding to C—C, C—N, and O—C═O were positioned at 284.6 eV, 285.2 eV, and 289.0 eV, as shown in FIG. 4B. FIG. 4C shows the Ce XPS spectrum, which consisted of six multiple peaks at 881.9 eV, 888.3 eV, 897.8 eV, 900.5 eV, 907.0 eV, and 916.3 eV relevant to 3d_{5/2} and 3d_{3/2} spectra. These multiple peaks connected to the spin-orbit splitting of the 3d_{5/2} and 3d_{3/2} core holes corresponded to the Ce in +3 and +4 oxidation. The two XPS spectral peaks of Mn 2p centered at 641.6 eV and 653.2 eV were due to spin-orbit splitting as Mn²⁺ (2p_{3/2}) and Mn³⁺ (2p_{1/2}) species with spacing around 11.5 eV, respectively as seen in FIG. 4D. This proves the insertion of Mn atoms into the CeO₂ lattice. FIG. 4E shows the core XPS spectrum for Zn 2p, which includes 2 peaks centered at 1044.4 eV and 1021.2 eV corresponding to tetrahedral Zn²⁺-linked Zn 2p_{1/2} and Zn 2p_{3/2}. FIG. 4F displays O1s spectra, which include two major peaks at 529.1 eV and 531.4 eV corresponding to the lattice oxygen or oxygen vacancy.

### Example 11: Fertilizer Performance

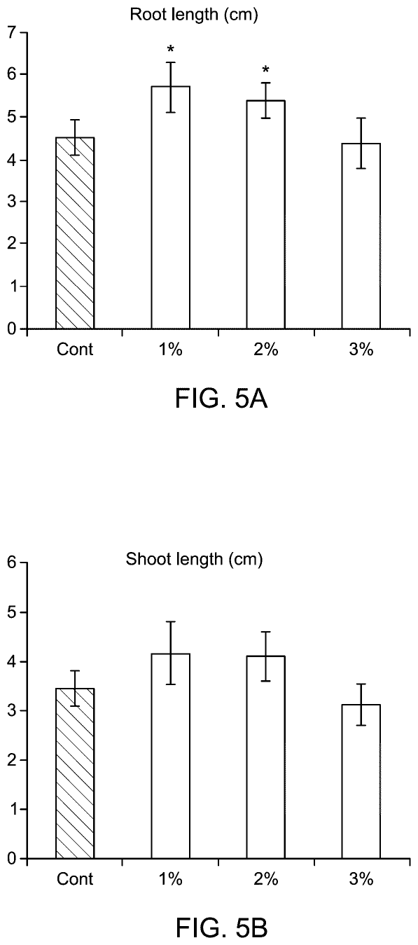

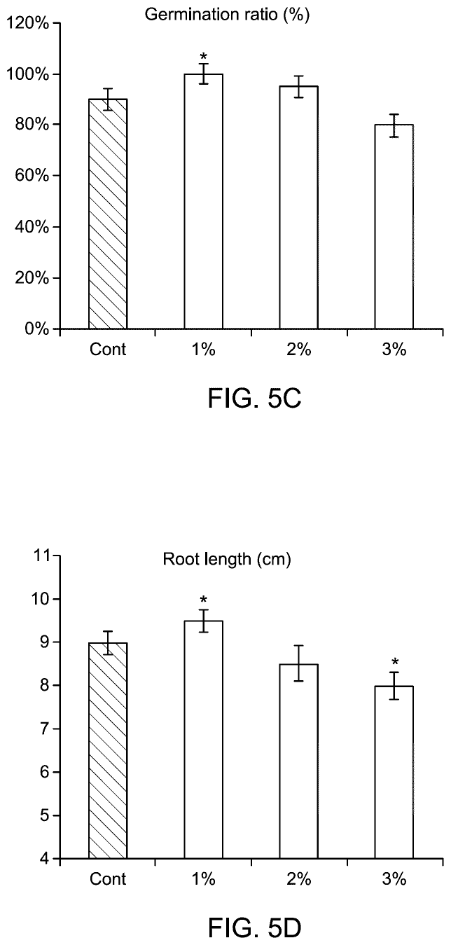

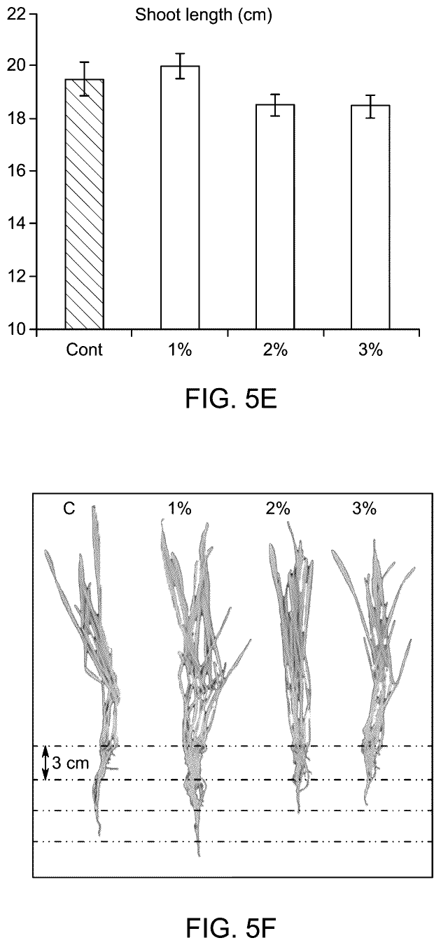

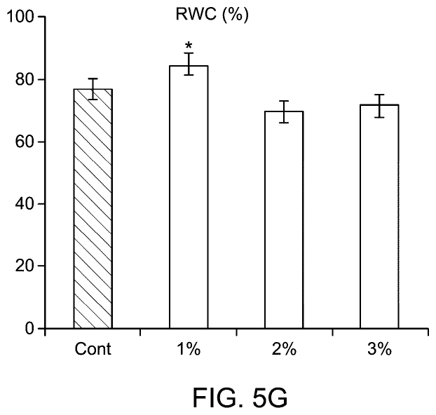

In the present disclosure, the barley seeds were germinated with NPs treatment for four days. The root and leaf lengths of the seedlings were measured before transferring them to the NP-included Hoagland solution as shown in FIG. 5A and FIG. 5B. Apart from the 3% NPs, the results demonstrated that NP treatment improved the roots more than the roots of the control specimen, p<0.05. The improvement of roots in 1% was more significant than the improvement in 2%. However, the shoots showed no discernible changes, as shown in FIG. 5B. The germination ratio was 90% in the control specimen and 100% under 1% of the NP treatment, as shown in FIG. 5C. 1% and 2% NPs gradually increased the germination percentage. However, the treatment of 3% NPs showed a slight depletion. After three weeks of being treated with NPs, the lengths of the roots and leaves were measured, as shown in FIG. 5D and FIG. 5E. It was observed that the root of the plant treated with 1% of NPs was longer than that of the control specimen. However, the root and shoot of the seedlings treated with 2% and 3% NPs were shorter than that of the control specimen, as shown in FIG. 5F. According to these findings, 1% of NPs positively impacted the growth of both root and shoot during the germination for four days and also positively impacted the growth for three weeks stages. This indicated that 1% of ZnMnCe NP is helpful in the development of barley seedlings. On the other hand, increasing the Zn and Mn ratio in the composition of NPs does not lead to growth improvement; in contrast, they cause growth inhibition and potential toxic effects.

The values of RWC are an indicator of the water condition of the plants. In general, NPs are known to modify ion channels or membrane pores to increase the capacity for water absorption. Therefore, RWC quantification is required to understand the role of NPs in facilitating the plants to use water efficiently. FIG. 5G shows the effects of NPs treatment on the RWC, in percentages in barley leaves. Compared to the control specimen, the plant treated with 1% of ZnMnCe NPs showed an increase in the RWC, unlike plants treated with 2% and 3% of NPs, which showed reduced RWC. Overall, treatment with 1% of ZnMnCe NPs improved the germination rate and growth indices of barley plants more than the plants without NPs treatment. Conversely, an increase of 2% to 3% in the Mn and Zn proportion in the NPs did not reflect a similar positive impact.

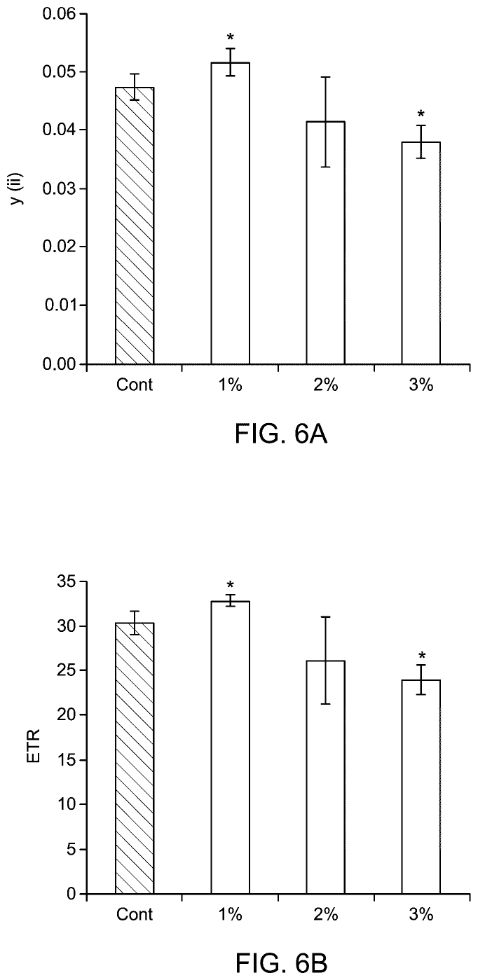

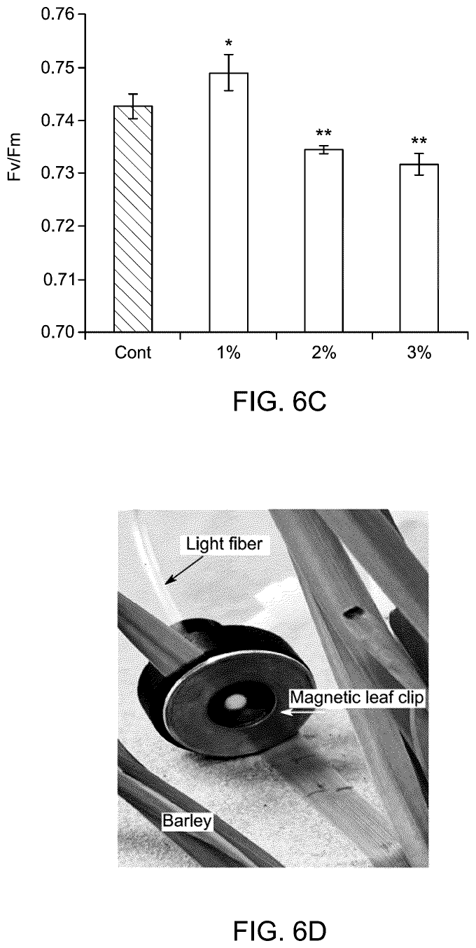

Measurement of the health status of a plant is related to the ability of the plant to produce photosynthetic pigments since these are the sites where all plants receive energy. The photosynthetic pigments may act as sensing elements for investigation of the physiology and metabolism rate of plants. Therefore, monitoring photosynthetic pigments and activities is an appropriate approach to show how stress situations may impact plants. Accordingly, the contents of chlorophyll a, chlorophyll b, total pigments, and carotenoids in the seedlings after NPs treatment for 3 weeks were determined as shown in FIGS. 6A-6D. The amount of all pigments in leaves was plotted against increasing NP ratios. The pigment contents against the increasing Mn and Zn ratio exhibited comparable graphical trends. For instance, 1% of NPs resulted in the highest pigmentation. This enhancement was significant (p<0.05 and p<0.01) in all tested pigment types with 1% NPs. On the other hand, a considerable reduction (p<0.05) occurred in chlorophyll-a and total pigments when 3% of NPs were applied. The results showed that 1% of NPs positively influence plant chlorophyll content and pigmentation. The pigment content of barley is affected by the ratio of Zn and Mn incorporated into the composition of NPs. Incorporating ZnMnCe NPs or their possible disassociation into the plant body contributes to metabolic processes or structures like chlorophyll and photosynthetic enzymes or reactions.

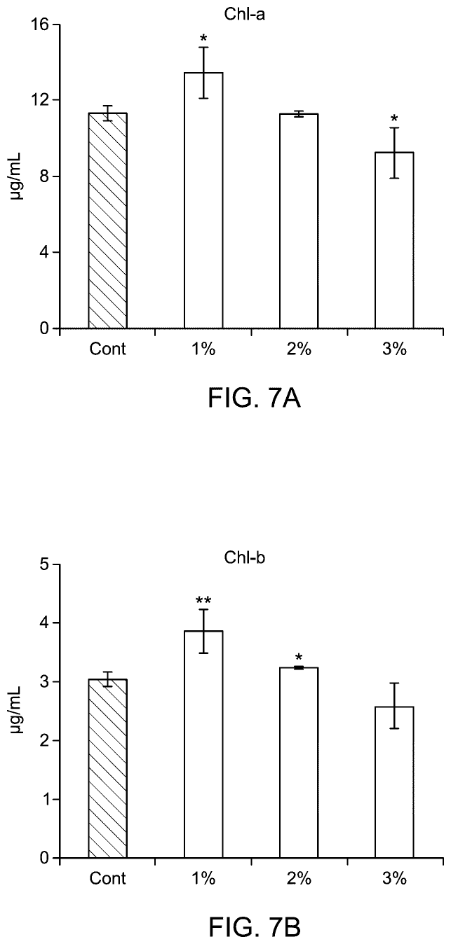

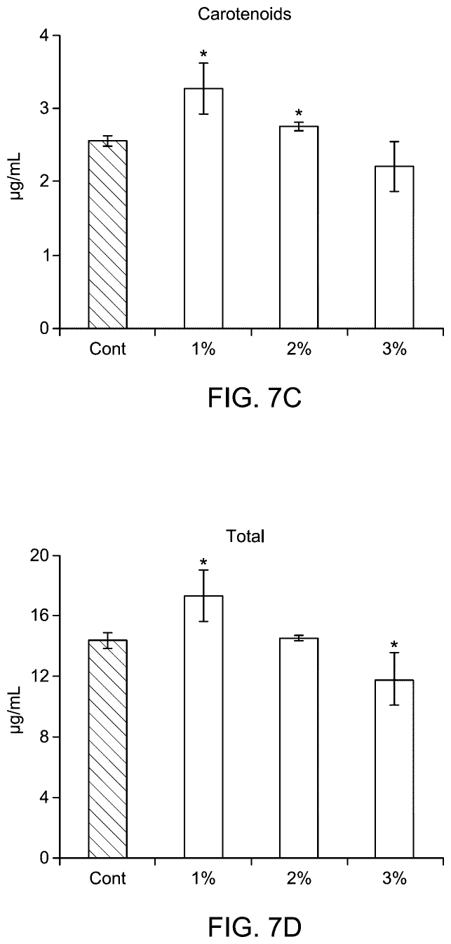

Apart from the total pigment content, the effect of different Zn and Mn ratios on the parameters of chlorophyll fluorescence (Fv/Fm), the effective photochemical quantum yield of the photosystem II, Y(II), and electron transport rate (ETR) was evaluated as shown in FIGS. 6A-6D. The chlorophyll fluorescence parameters were increased for the plants treated with 1% NPs (p<0.05) and were gradually decreased when the NPs contents were increased to 2% and 3%, as shown in FIGS. 6A-6C. These parameters coincide with the findings for growth indices, as shown in FIGS. 5A-5G and pigment contents are shown in FIGS. 7A-7D.

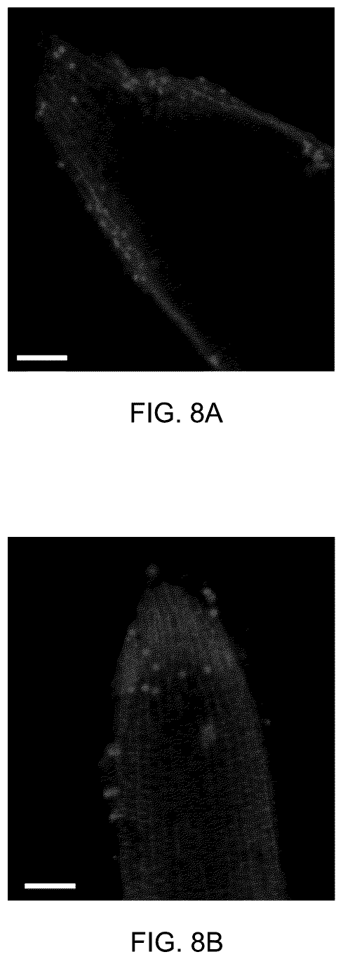

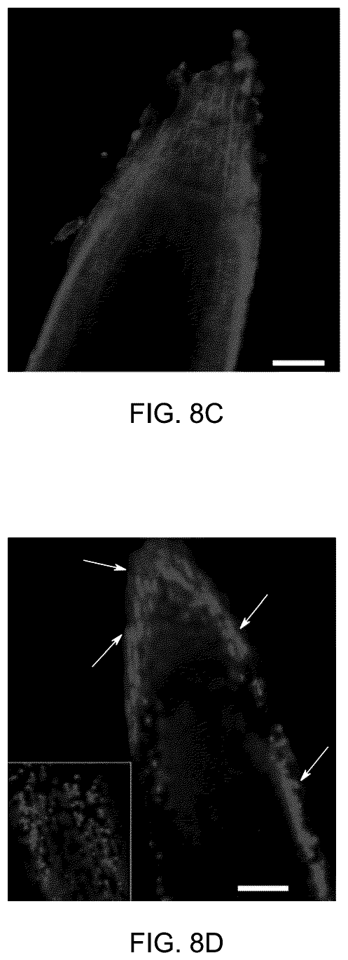

The cell viability, which is the potential cell damage due to the treatment of ZnMnCe NPs in the roots of barley plants, was evaluated. FIGS. 8A-8E shows the results of both control root tips and NP-treated root tips of barley seedlings. The spots indicate the nucleus of cells, which is stained due to the cell membrane damage. No damaged cells were found in the control, 1%, and 2% NP-treated specimens. However, the 3% NP-treated specimen caused cell membrane damage, as shown in FIG. 8D. Further, the number of injured cells was higher at the upper sites of the root tips, at about 1 cm. These results indicated that 1% and 2% of NPs do not lead to cell membrane damage. However, 3% of NPs disrupt the cell membrane integrity, indicating a toxic effect on plant cells. This result aligns with the growth indices and plant photosynthetic and pigmentation parameters, as shown in the previous sections.

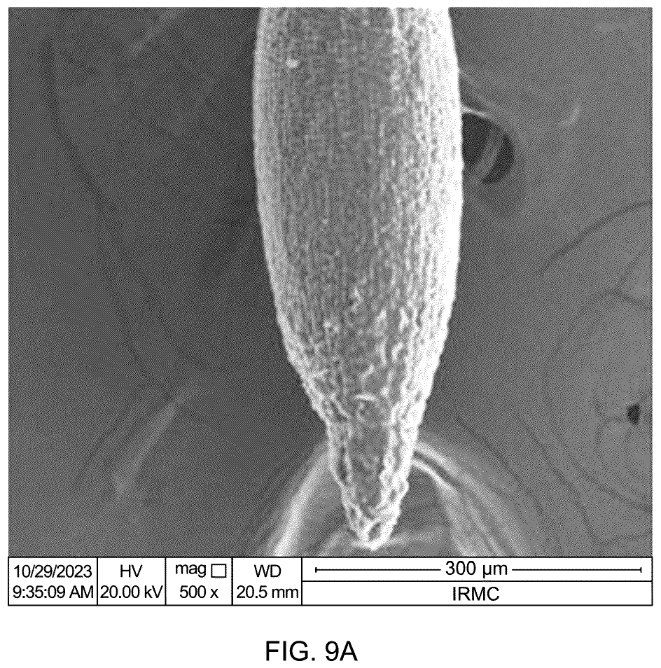

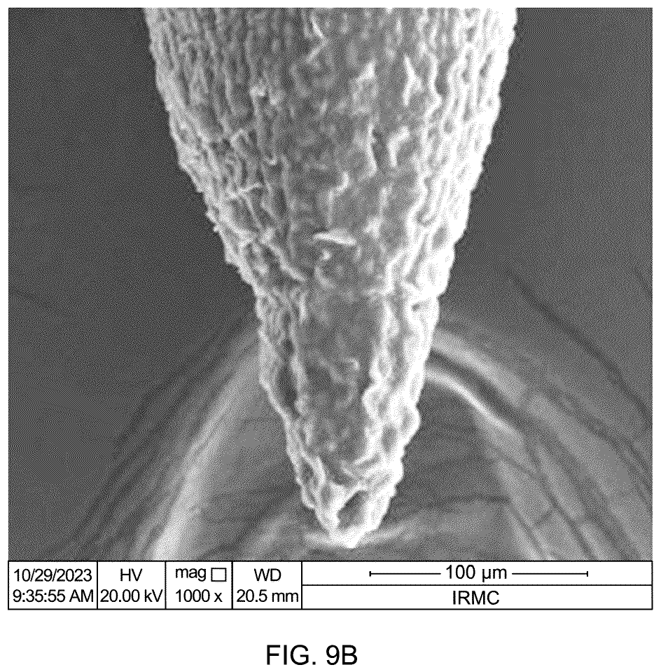

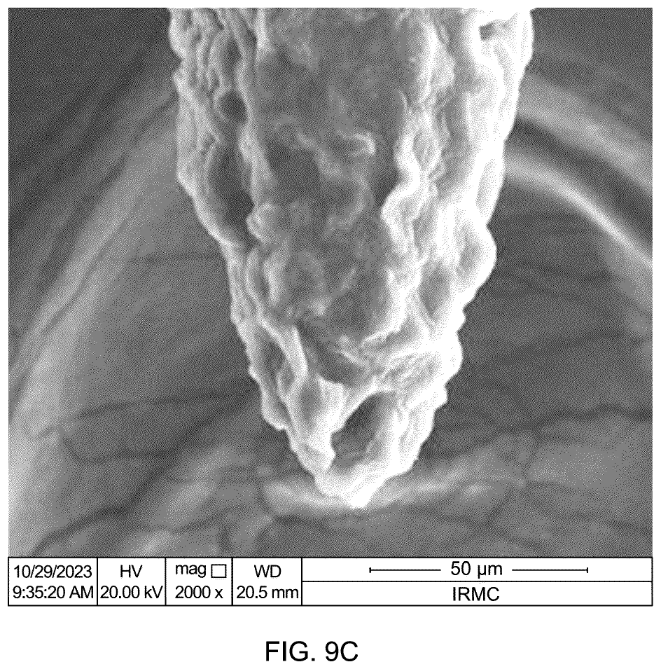

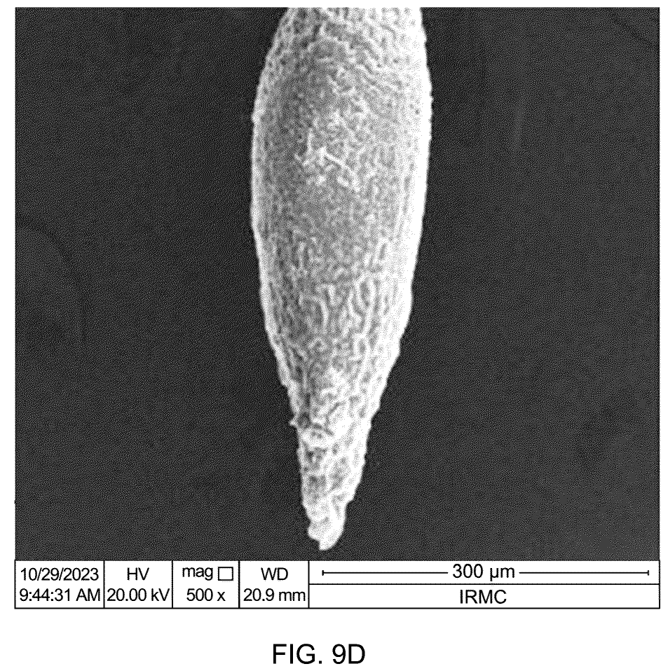

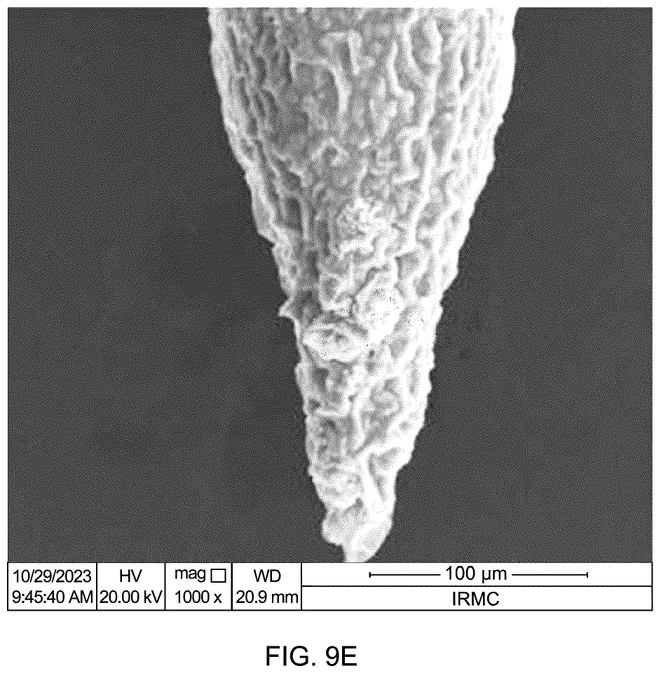

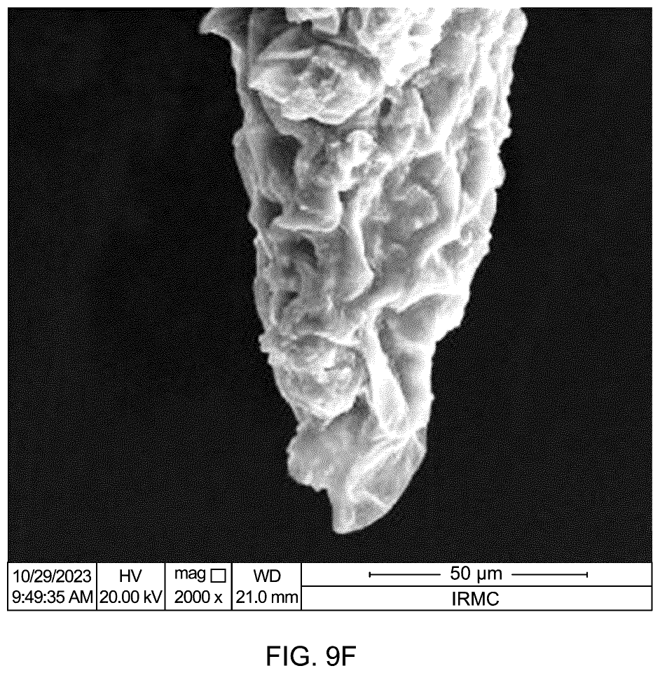

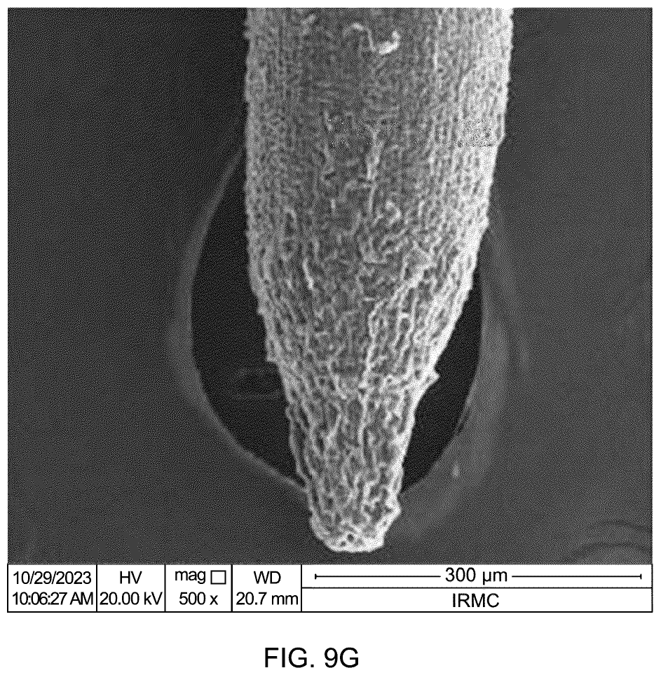

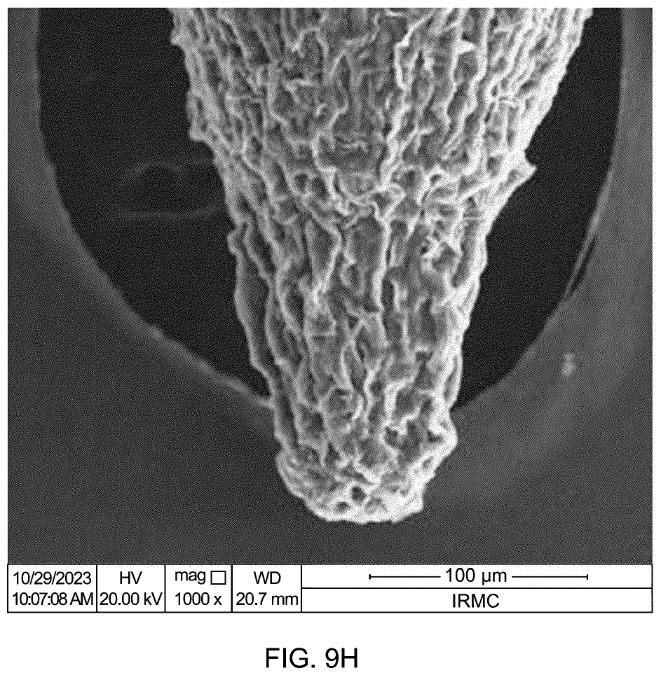

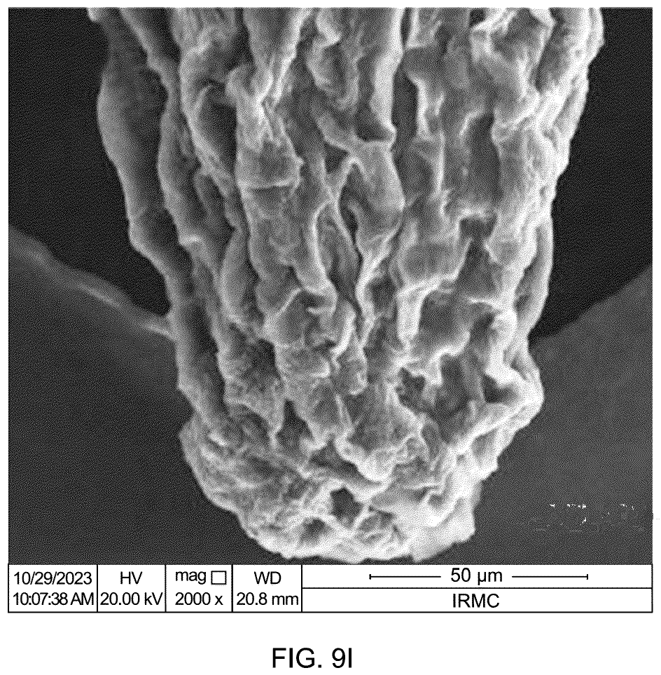

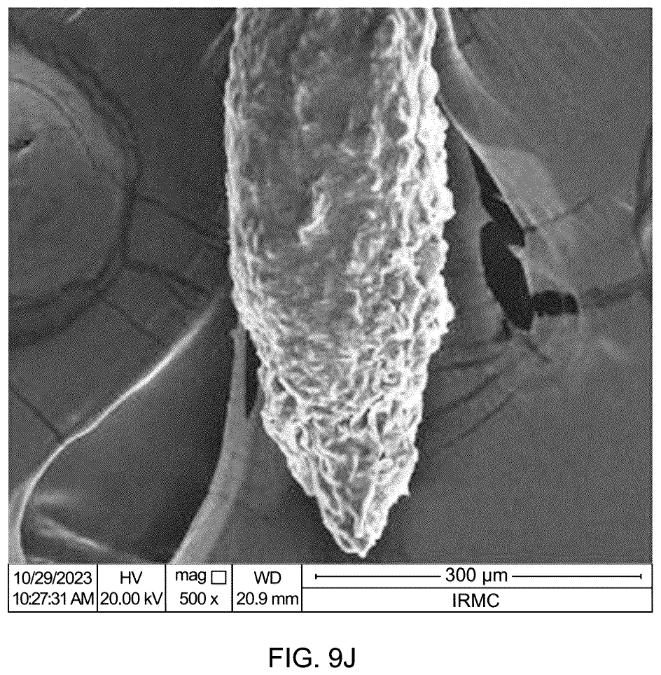

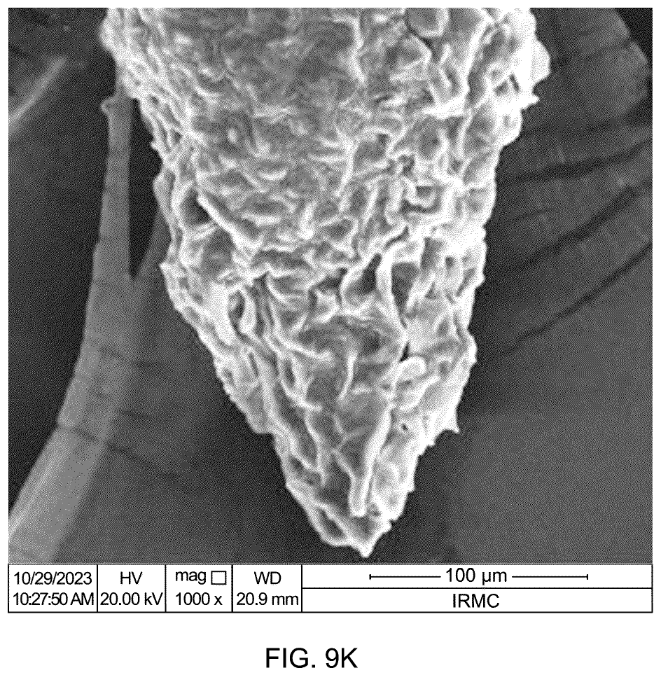

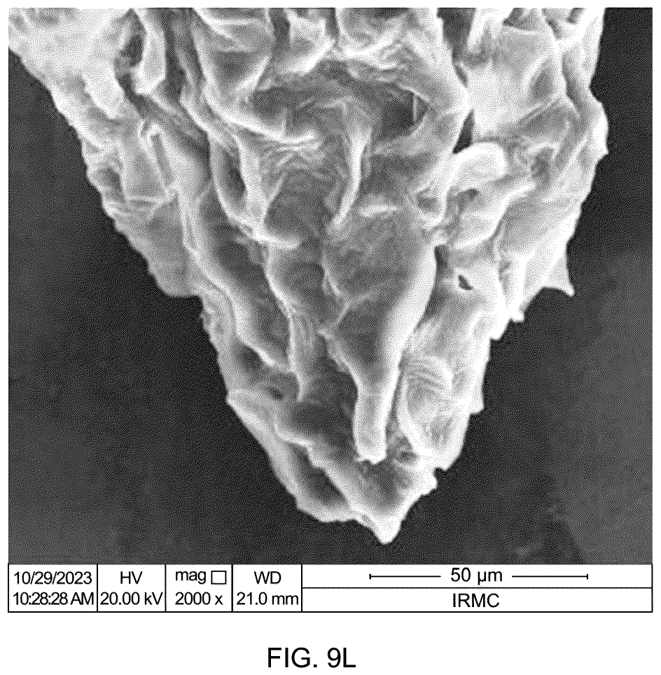

FIGS. 9A-9L shows the SEM images of 0.5 cm of root tips of the control specimen and NP-treated barley plants. The SEM images revealed that the morphology of root tips was different in ZnMnCe NP-treated roots compared to that of the control root tips. The root surface of the control specimen was smooth and complete as shown in FIGS. 9A-9C. However, signs of fractures and bulges appeared in the NP-treated roots. Further, cracks on the surface of the NP-treated roots, which began to peel off, may be seen in the 3% treated root tips, as shown in FIGS. 9J-9L. The morphological changes were more apparent when the Zn and Mn percentages were increased. This result indicates that the application of 2% ZnMnCe NPs, and 3% ZnMnCe NPs disrupts the root morphology, which may affect the nutrient trafficking and homeostasis that eventually influence the physical condition and growth of the barley seedlings. This observation supported the confocal microscopic images of FIGS. 8A-8D and the results of growth indices and physiological parameters derived from FIGS. 5A-5G, FIGS. 6A-6D, and FIGS. 7A-7D.

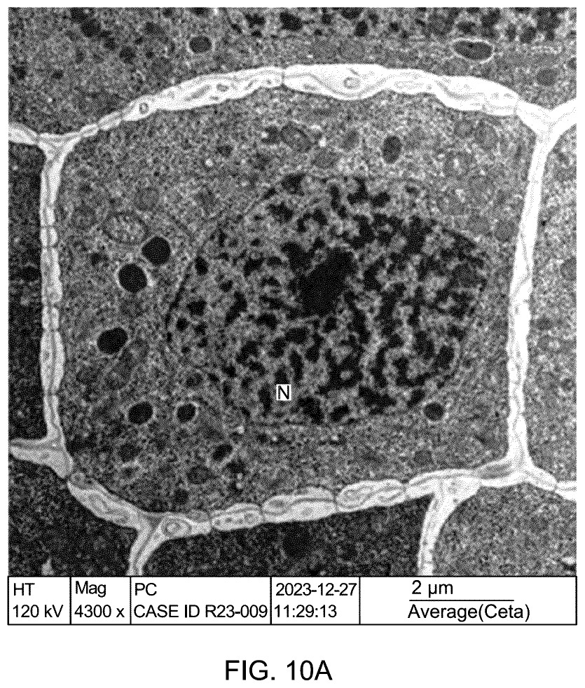

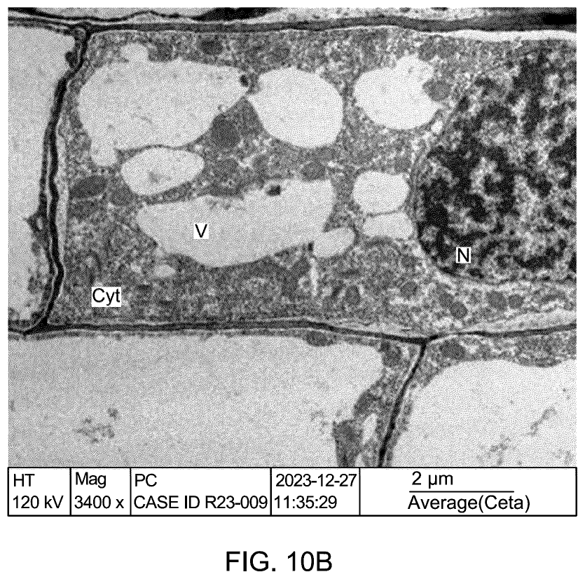

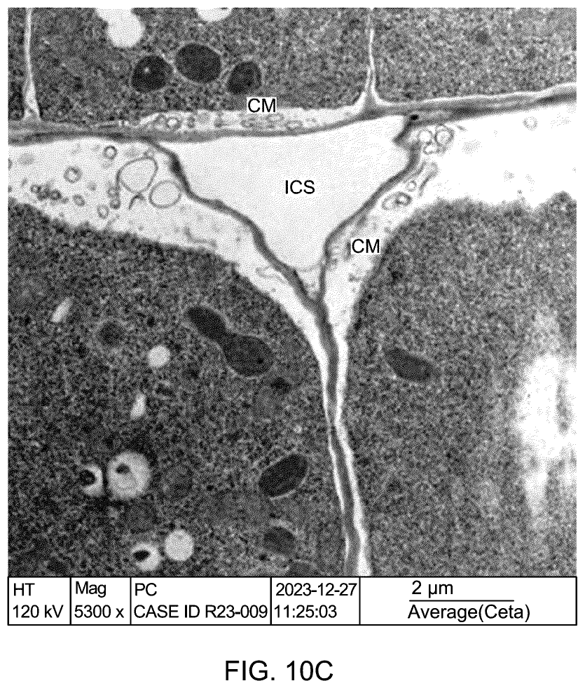

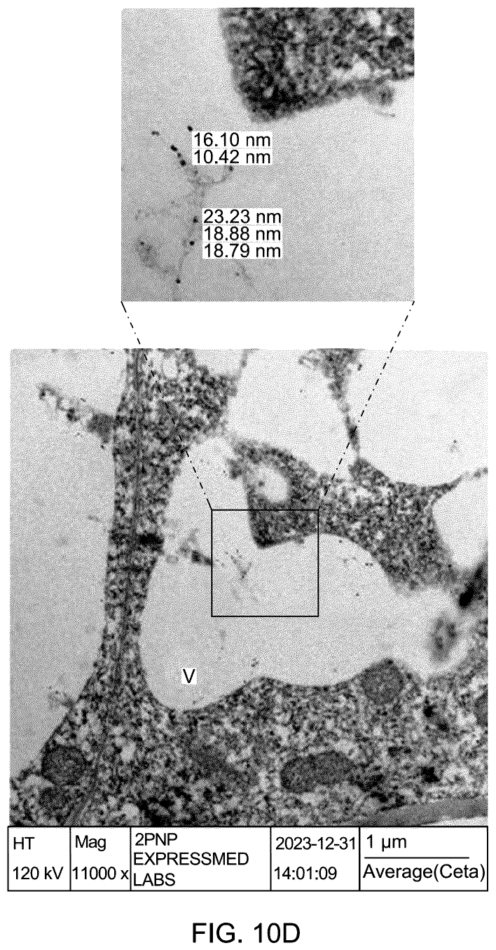

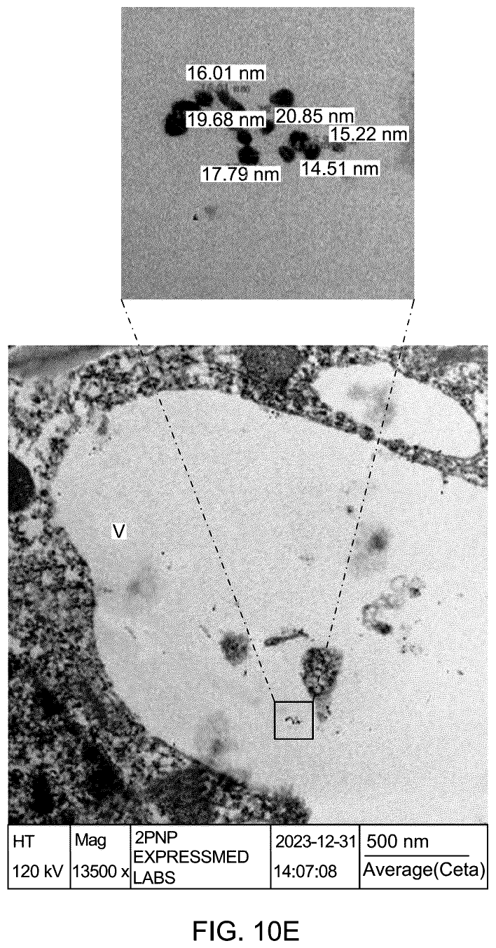

FIGS. 10A-10C illustrate the HRTEM images of barley roots of the control specimen and FIGS. 10D-10E illustrates the micrographs of 3% ZnMnCe NPs-treated barley roots. There is no NP sign in the control. However, NPs were observed at different fractions of the cells such as in cytoplasm and vacuoles subjected to NP-treated specimens. The result also denotes the encapsulation of NPs in vacuoles. At a magnification of 240,000×, the size of the detected NPs was in the range of 16 nm to 20 nm. This result aligns with the size distribution of ZnMnCe NPs, which was around 11 nm to 14 nm in Table 1. These findings revealed that ZnMnCe NPs were penetrated to the root cell. No traces of NPs were found in the leaves, which is due to blockage by biological barriers in the roots and stems of the plants, such as cell membranes, cell walls, sieve elements, casparian strips, and the like. Further, apoplastic or symplastic pathways are the main routes of NP translocation. Apoplastic transport occurs in the extracellular regions, adjacent cell walls, and xylem vessels rather than inside the plasma membrane, whereas symplastic transport uses plasmodesmata and sieve plates, which are specialized structures to transfer water and substances from the cytoplasm of one cell to the cytoplasm of another. The NPs use the pores at the cell membranes, cell walls, or plasmodesmata to reach the cell. Once penetrated, they may interact strongly with the biomolecules, including DNA, protein, and lipids that may interfere with the bioprocesses and, eventually, the overall plant growth. Overall, the TEM micrograph analysis of the present disclosure showed the roots of barley uptake of ZnMnCe NPs. However, the NPs were not located in the aboveground tissues due to their restricted or limited transfer through the cells.

ICP-OES technique was used to quantify the incorporated NPs translocation and their impact on the nutrition, macro elements, and micro elements of the barley roots and leaves. The content of microelements such as Mn, Zn, iron (Fe), copper (Cu), and boron (B) in the barley tissues without and with NPs treatment is shown in Table 2, and the content of macro elements such as calcium (Ca), potassium (K), and magnesium (Mg) in the barley tissues without and with NPs treatment is shown in Table 3. The increase in the proportion of Zn—Mn in the NPs gradually increased the abundance of elements in the nutrients of the plant.

Plants treated with 3% of NPs showed a content of Mn of 0.671 milligrams per kilogram (mg/kg) in dry weight (DW) in the roots and 0.677 mg/kg in DW in the shoots. These contents of Mn in roots and shoots of plants treated with 3% of NPs are eight times the contents of Mn in the tissues of control specimens, which is 0.072 mg/kg in DW in the roots and 0.087 mg/kg in DW in the shoots.

Further, Zn contents of 0.492 mg/kg in DW in barley roots reached nearly 27 times that of the control specimens, which is 0.018 mg/kg in DW and approximately nine times in the shoots. This may lead to a toxic effect, resulting in reduced growth performance in barley. However, when 1% NPs were applied, a concentration of 0.121 mg/kg in DW of Mn and a concentration of 0.075 mg/kg in DW of Zn were observed in the roots, and a concentration of 0.075 mg/kg in DW of Mn and a concentration of 0.391 mg/kg in DW of Zn were observed in the shoots. These concentrations are higher than those of the control specimen (p<0.005). The growth enhancement of barley seedlings was partly due to the increased uptake of various elements that result from applying 1% NPs. The present disclosure demonstrated that the plant roots absorbed Zn—Mn-doped cerium oxide NPs, which resulted in an upregulation of various chemical elements like K, Ca, Mg, Fe, Cu, and B in both the leaves and roots (p<0.005), as shown in Table 2 and Table 3.

TABLE 2
Microelement concentration in the barley roots and leaves without and with NPs treated samples.

| | | Microelements (mg/kg DW) | | | | |
|---|---|---|---|---|---|---|
| Tissue | Sample | Mn | Zn | Fe | Cu | B |
| Root | Control | 0.072 ±0.0002 | 0.018 ± 0.0.0001 | 0.395 ± 0.0064 | 0.006 ± 0.0004 | 0.008 ± 0.0002 |
| | 1% | 0.121 ± 0.0027* | 0.075 ± 0.0004*** | 0.387 ± 0.005 | 0.005 ± 0.0004*** | 0.023 ± 0.0009*** |
| | 3% | 0.671 ± 0.0104*** | 0.492 ± 0.0053*** | 0.545 ± 0.0106*** | 0.466 ± 0.0155*** | 0.013 ± 0.0001*** |
| Leaf | Control | 0.087 ± 0.0012 | 0.097 ± 0.0016 | 0.385 ± 0.0029 | 0.020 ± 0.0006 | 0.029 ± 0.0002 |
| | 1% | 0.367 ± 0.009*** | 0.391 ± 0.0016*** | 0.676 ± 0.0068*** | 0.028 ± 0.0006*** | 0.184 ± 0.0022*** |
| | 3% | 0.677 ± 0.0109*** | 0.712 ± 0.0091*** | 0.575 ± 0.0109*** | 0.217 ± 0.0039*** | 0.115 ± 0 |

The asterisk (*) symbol denotes a significant difference between treatment and control (*p < 0.05,
**p < 0.01,
***p < 0.005).

TABLE 3
Microelement concentration in the barley roots and
leaves without and with NPs treated samples.

| | | Macroelements (mg/kg DW) | | |
|---|---|---|---|---|
| Tissue | Sample | Ca | K | Mg |
| Root | Control | 9.566 ± 0.0467 | 5.564 ± 0.0207 | 1.276 ± 0.0037 |
| | 1% | 19.57 ± 0.136*** | 14.65 ± 0.129*** | 3.832 ± 0.0137*** |
| | 3% | 19.64 ± 0.324*** | 12.82 ± 0.075*** | 3.098 ± 0.012*** |
| Leaf | Control | 42.92 ± 0.643 | 101.1 ± 1.25 | 7.994 ± 0.0376 |
| | 1% | 82.55 ± 0.795*** | 230.7 ± 0.0.88*** | 23.85 ± 0.769*** |
| | 3% | 84.34 ± 2.352*** | 183.1 ± 2.18*** | 18.23 ± 0.155*** |

The asterisk (*) symbol denotes a significant difference between treatment and control (*p < 0.05, **p < 0.01, ***p < 0.005).

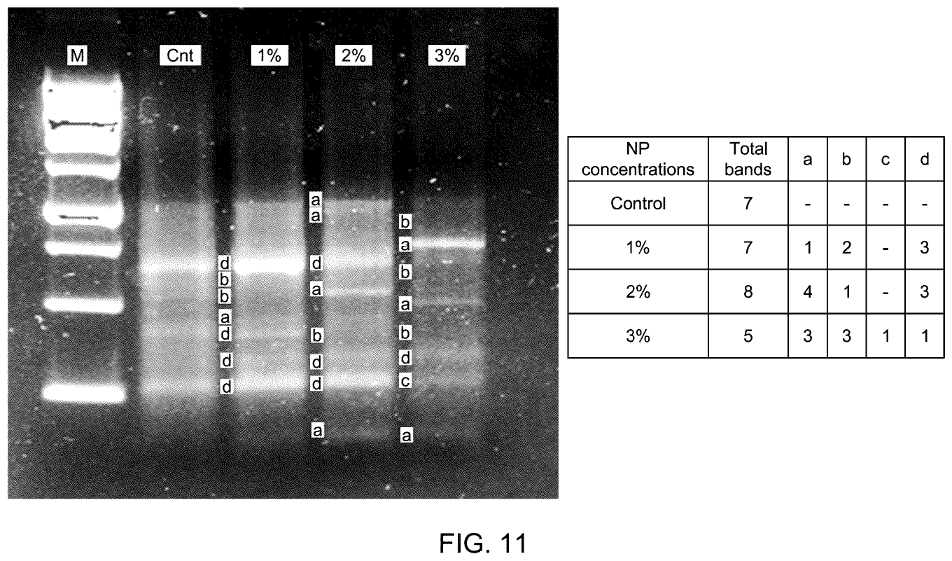

To assess the genotoxicity impact of ZnMnCe NPs on the barley plants a RAPD-PCR analysis was performed. The genotoxic effects of the toxicants include DNA variants, DNA damage, genetic instabilities, and mutagenic consequences. RAPD-PCR analysis quickly and efficiently compares the banding patterns of genomic DNA between the control and NP-treated specimens. The RAPD-PCR patterns of the NP-treated and control barley plants were compared based on specific band changes, increasing or decreasing trends in the band intensity, and loss or gain of the bands were recorded as shown in FIG. 11. Table 4 shows the number of total bands, gained bands, disappeared bands, and bands with increased and decreased intensity. The RAPD profiles of the control and treated plants differ with alterations such as fading, and emergence of DNA band numbers generated by the OPA-8 primer.

TABLE 4
RAPD-PCR band patterns of ZnMnCe NPs-
treated and control barley roots.

| NP | | | Loss of | Band | Band |
|---|---|---|---|---|---|
| concentra- | Total | Emergence of | normal | intensity | intensity |
| tions | bands | new bands | bands | decrease | increase |
| Control | 7 | — | — | — | — |
| 1% | 7 | 1 | 2 | — | 3 |
| 2% | 8 | 4 | 1 | — | 3 |
| 3% | 5 | 3 | 3 | 1 | 1 |

Plants treated with 1% of ZnMnCe NPs revealed the emergence of 1 new-fangled band, fading of 2 average bands, and 3 band intensities enhancements. Plants treated with 2% of ZnMnCe NPs showed the emergence of 4 new bands, loss of 1 average band, and 3 band intensities enhancements. Plants treated with 3% of ZnMnCe NPs displayed the emergence of 3 new bands, loss of 3 regular bands, 1 band intensity improvement, and 1 band intensity quenching, as shown in FIG. 11. Incorporating ZnMnCe NPs into the barley plants was responsible for the changes in RAPD band pattern and intensity. However, due to the minute proportion of Mn and Zn contents in the NPs, any genomic mutation or alteration at the sites of oligonucleotide primers that have produced the gain or loss of bands is not caused. The observed appearance of new bands in the profile are due to the DNA damage-induced instability of the genomic sequence. Point mutation or damage to the binding sites of the primers may not have caused these changes, which may prevent or decrease the effectiveness of the polymerization of DNA in the PCR reaction mechanism. The accessibility of few oligonucleotide primers was due to the structural changes or DNA sequence alteration stimulated by a large number of removals that brought two pre-existed annealing sites close to each other, mutations that may produce new annealing event, or homologous recombination, the appearance of new bands juxtaposing two sequences that matched to the primer sequences. This confirmed that the alteration of the RAPD bands pattern of the NP-treated plants is more significant than that of the control specimen, which may be related to point mutation, the manifestation of the genomic instabilities like point mutation, rearrangement of gene and chromosome, deletion, and insertion. In short, plants treated with 2% and 3% of ZnMnCe NPs disclosed considerable genomic DNA instability.

Numerous modifications and variations of the present disclosure are possible in light of the above teachings. It is therefore to be understood that within the scope of the appended claims, the invention may be practiced otherwise than as specifically described herein.

1. A method of fertilizing a plant, comprising:
applying a composition to a root of the plant,
wherein the composition comprises:
cerium oxide (CeO) nanoparticles,
wherein the CeO nanoparticles are doped with zinc and manganese,
wherein the CeO nanoparticles comprise 1-3 wt. % of the zinc and 1-3 wt. % of the manganese, based on a total weight of the CeO nanoparticles.

2. The method of claim 1, wherein the CeO nanoparticles are spherical.

3. The method of claim 1, wherein the CeO nanoparticles an average size of 10-50 nm.

4. The method of claim 1, wherein the CeO nanoparticles comprise 45-60 wt. % Ce, 1-3 wt. % Zn, 1-3 wt. % Mn, and 25-40 wt. % O, based on a total weight of the CeO nanoparticles.

5. The method of claim 1, wherein the CeO nanoparticles have a crystallite size of 10-14 nm.

6. The method of claim 1, wherein the CeO nanoparticles have a ceria cubic crystal structure.

7. The method of claim 1, wherein the CeO nanoparticles comprise Ce(III), Ce(IV), Mn(II), Mn(III), and Zn (II).

8. The method of claim 1, wherein the plant is a barley.

9. The method of claim 1, wherein the plant is under conditions of 22-25° C., 55-70% humidity, and 14-18 hours of light per day.

10. The method of claim 1, wherein the applying comprises at least partially submerging the root of the plant in a fertilizer solution comprising the composition.

11. The method of claim 10, wherein the fertilizer solution comprises 1-500 mg/L of the composition.

12. The method of claim 11, wherein the fertilizer solution further comprises at least one compound selected from the group consisting of potassium nitrate, calcium nitrate, magnesium sulfate, potassium dihydrogen phosphate, ammonium dihydrogen phosphate, manganese chloride, zinc sulfate, copper sulfate, molybdic acid, sodium molybdate, ferric tartrate, iron(iii)-EDTA, and hydrates thereof.

13. The method of claim 1, wherein the plant uptakes the particles of the composition, and wherein leaves of the plant have a higher concentration of Zn, Ce, and Mn compared to a plant under the same conditions but without applying the composition.

14. The method of claim 1, wherein following the applying a root length of the plant is at least 10% longer compared to a plant under the same conditions but without applying the composition.

15. The method of claim 1, wherein following the applying the plant has a higher concentration of chlorophyll-a, chlorophyll-b, and carotenoids than a plant under the same conditions but without applying the composition.

16. The method of claim 1, wherein the CeO nanoparticles comprise 1 wt. % of the zinc and 1 wt. % of the manganese, based on a total weight of the CeO nanoparticles, and
wherein the CeO nanoparticles do not damage a cell membrane or root morphology of the plant.

17. The method of claim 1, wherein the composition further comprises a pesticide.

18. The method of claim 17, wherein the pesticide is attached to a surface of the particles of the CeO nanoparticles.
